(19) United States
(12) Patent Application Publication
(10) Pub. No.: US 2011/0092632 A1
(43) Pub. Date: Apr. 21, 2011

(54) POROUS INORGANIC MATERIALS CONTAINING POLYMER ADDITIVES

(76) Inventors: FABIEN JEAN BRAND, Huningue (FR); Patrice Bujard, Courtepin (CH); Holger Hoppe, Lorrach (DE); Martin Müller, Lorrach (DE); Michael Tinkl, Eiken (CH)

(21) Appl. No.: 12/961,600

(22) Filed: Dec. 7, 2010

Related U.S. Application Data
(63) Continuation of application No. 11/631,551, filed on Jan. 4, 2007, now abandoned.

(30) Foreign Application Priority Data
Jul. 16, 2004 (EP) 04103403.4

(51) Int. Cl. C08K 3/36

(52) U.S. Cl. 524/493

(57) ABSTRACT

The present invention relates to SiO_{z} flakes, especially porous SiO_{z} flakes, wherein 0.70≦z≦2.0, especially 0.95≦z≦2.0, comprising a polymer additive in the pores, which provides enhanced (long term) efficacy. Further aspects of the invention are a process for their preparation and a polymer composition containing such SiO_{z} flakes.

This application is a continuation of application Ser. No. 11/631,551, pending, which is a national stage of PCT/EP2005/053216, filed Jul. 6, 2005, the contents of which applications are incorporated by reference.

The present invention relates to SiO_{z} flakes prepared by physical vapor deposition (PVD), especially porous SiO_{z} flakes, wherein 0.70≦z≦2.0, especially 0.95≦z≦2.0, comprising an polymer additive in the pores, which provides enhanced (long term) efficacy. Further aspects of the invention are a process for their preparation and a polymer composition containing such SiO_{z} flakes.

Porous materials containing additives are, for example, described in U.S. Pat. Nos. 4,011,898 and 4,938,955. The porous materials disclosed are antibiotic zeolites, which can be prepared by replacing all or part of the ion-exchangeable ions in zeolite with antibiotic metal ions.

Polymer additives in masterbatches or in the final polymers may migrate, exude or degrade in some cases. This may happen during processing of the polymers or during their use, in particular their outdoor use, where the influence of actinic radiation and weather determine the additive and polymer's lifetime.

It has now been found that a variety of polymer additives show an improved effect and an enhanced durability during processing and/or use when incorporated into cavities or pores formed by SiO_{z} flakes prepared in a specific vapor deposition process.

The present invention provides a composition of an polymer additive distributed in porous inorganic materials, especially porous silicon oxides, with high uniformity of thickness and/or high effective surface area, with a high degree of plane parallelism and a defined thickness in the region of ±10%, preferably ±5%, of the average thickness and/or defined porosity.

One aspect of the invention is a composition comprising

a) a porous SiO_{z} flake prepared by physical vapor deposition, wherein 0.70≦z≦2.0 which has incorporated at least partly in the pores

b) a polymer additive selected from the group consisting of light stabilizers, heat stabilizers, metal deactivators, processing stabilizers, acid scavengers, anti-blocking agents, anti-fogging agents, antistatic agents, flame retardants, hydrophilic/hydrophobic surface modifiers, IR-reflectors, IR-absorbers, nucleating agents, scratch resistance additives and thermally conductive additives.

The term “SiO_{z} with 0.70≦z≦2.0” means that the molar ratio of oxygen to silicon at the average value of the silicon oxide substrate is from 0.70 to 2.0. The composition of the silicon oxide substrate can be determined by ESCA (electron spectroscopy for chemical analysis). The stoichiometry of silicon and oxygen of the silicon oxide substrate can be determined by RBS (Rutherford-Backscattering).

Preferably in the porous SiO_{z} z is 0.95≦z≦2.0.

According to the present invention the term “SiO_{z} flakes comprising a polymer additive includes that the whole surface or parts of the surface of the (porous) SiO_{z} flakes is covered by the polymer additive, that the pores or parts of the pores of the porous SiO_{z} flakes are filled with the polymer additive and/or that the SiO_{z} flakes are coated at individual points or domains therewith. Preferably, more than 50% of the pores of the porous SiO_{z} flakes are filled. As the size of the pores of the SiO_{z} flakes can be controlled by the process for the production of the porous SiO_{z} flakes to be in the range of from ca. 1 to ca. 50 nm, especially ca. 2 to ca. 20 nm, it is, for example, possible to create nanosized particles within the pores of SiO_{z} flakes.

The porous plate-like (plane-parallel) SiO_{z} structures (SiO_{z} flakes) used according to the present invention have a length of from 100 nm to 5 mm, a width of from 100 nm to 2 mm, and a thickness of from 20 nm to 1.5 μm, and a ratio of length to thickness of at least 2:1, the particles having two substantially parallel faces, the distance between which is the shortest axis of the particles. The porous SiO_{z} flakes are mesoporous materials, i.e. have pore widths of ca. 1 to ca. 50 nm, especially 2 to 20 nm. The pores are randomly inter-connected in a three-dimensional way. So, when used as a support, the passage blockage, which frequently occurs in SiO₂ flakes having a two-dimensional arrangement of pores can be prevented. The specific surface area of the porous SiO_{z} flakes depends on the porosity and ranges from 50 m²/g to more than 1000 m²/g. Preferably, the porous SiO_{z} flakes have a specific surface area of greater than 500 m²/g, especially greater than 600 m²/g. The BET specific surface area is determined according to DIN 66131 or DIN 66132 (R. Haul and G. Dümbgen, Chem.-Ing.-Techn. 32 (1960) 349 and 35 (1063) 586) using the Brunauer-Emmet-Teller method (J. Am. Chem. Soc. 60 (1938) 309).

The (porous) SiO_{z} flakes are not of a uniform shape. Nevertheless, for purposes of brevity, the flakes will be referred to as having a “diameter.” The SiO_{z} flakes have a plane-parallelism and a defined thickness in the range of ±10%, especially ±5% of the average thickness. The SiO_{z} flakes have a thickness of from 20 to 2000 nm, especially from 100 to 500 nm. It is presently preferred that the diameter of the flakes is in a preferred range of about 1-60 μm with a more preferred range of about 5-40 μm and a most preferred range of about 5-20 μm. Thus, the aspect ratio of the flakes of the present invention is in a preferred range of about 2.5 to 625 with a more preferred range of about 50 to 250.

The porous SiO_{z} flakes can also be milled or a dispersant can be added prior to their use.

The present invention is illustrated in more detail on the basis of the porous SiO_{z} flakes, which are preferred over non-porous SiO_{z} flakes, which can be prepared according to a process described in WO04/035693.

The porous SiO_{z} flakes are obtainable by a process described in U.S. Pat. No. 7,594,962. Said process comprises the steps of:

a) vapor-deposition of a separating agent onto a carrier to produce a separating agent layer,

b) the simultaneous vapor-deposition of SiO_{y} and a separating agent onto the separating agent layer (a),

c) the separation of SiO_{y} from the separating agent, wherein 0.70≦y≦1.80.

The platelike material can be produced in a variety of distinctable and reproducible variants by changing only two process parameters: the thickness of the mixed layer of SiO_{y} and separating agent and the amount of the SiO_{y} contained in the mixed layer.

The term “SiO_{y} with 0.70≦y≦1.80” means that the molar ratio of oxygen to silicon at the average value of the silicon oxide layer is from 0.70 to 1.80. The composition of the silicon oxide layer can be determined by ESCA (electron spectroscopy for chemical analysis). The stoichiometry of silicon and oxygen of the silicon oxide layer can be determined by RBS (Rutherford-Backscattering).

The separating agent vapor-deposited onto the carrier in step a) may be a lacquer (surface coating), a polymer, such as, for example, the (thermoplastic) polymers, in particular acryl- or styrene polymers or mixtures thereof, as described in U.S. Pat. No. 6,398,999, an organic substance soluble in organic solvents or water and vaporisable in vacuo, such as anthracene, anthraquinone, acetamidophenol, acetylsalicylic acid, camphoric anhydride, benzimidazole, benzene-1,2,4-tricarboxylic acid, biphenyl-2,2-dicarboxylic acid, bis(4-hydroxyphenyl)sulfone, dihydroxyanthraquinone, hydantoin, 3-hydroxybenzoic acid, 8-hydroxyquinoline-5-sulfonic acid monohydrate, 4-hydroxycoumarin, 7-hydroxycoumarin, 3-hydroxynaphthalene-2-carboxylic acid, isophthalic acid, 4,4-methylene-bis-3-hydroxynaphthalene-2-carboxylic acid, naphthalene-1,8-dicarboxylic anhydride, phthalimide and its potassium salt, phenolphthalein, phenothiazine, saccharin and its salts, tetraphenylmethane, triphenylene, triphenylmethanol or a mixture of at least two of those substances. The separating agent is preferably an inorganic salt soluble in water and vaporisable in vacuo (see, for example, DE 198 44 357), such as sodium chloride, potassium chloride, lithium chloride, sodium fluoride, potassium fluoride, lithium fluoride, calcium fluoride, sodium aluminium fluoride and disodium tetraborate.

In detail, a salt, for example NaCl, followed successively by a layer of silicon suboxide (SiO_{y}) and separating agent, especially NaCl or an organic separating agent, is vapor-deposited onto a carrier, which may be a continuous metal belt, passing by way of the vaporisers under a vacuum of <0.5 Pa.

The mixed layer of silicon suboxide (SiO_{y}) and separating agent is vapor-deposited by two distinct vaporizers, which are each charged with one of the two materials and whose vapor beams overlap, wherein the separating agent is contained in the mixed layer in an amount of 1 to 60% by weight based on the total weight of the mixed layer.

The thicknesses of salt vapor-deposited are about 20 nm to 100 nm, especially 30 to 60 nm, those of the mixed layer from 20 to 2000 nm, especially 50 to 500 nm depending upon the intended characteristics of the product.

The carrier is immersed in a dissolution bath (water). With mechanical assistance, the separating agent layer rapidly dissolves and the product layer breaks up into flakes, which are then present in the solvent in the form of a suspension. The porous silicon oxide flakes can advantageously be produced using an apparatus described in U.S. Pat. No. 6,270,840.

The suspension then present in both cases, comprising product structures and solvent, and the separating agent dissolved therein, is then separated in a further operation in accordance with a known technique. For that purpose, the product structures are first concentrated in the liquid and rinsed several times with fresh solvent in order to wash out the dissolved separating agent. The product in the form of a solid, that is still wet, is then separated off by filtration, sedimentation, centrifugation, decanting or evaporation.

A SiO_{1.00-1.8} layer is formed preferably from silicon monoxide vapour produced in the vaporiser by reaction of a mixture of Si and SiO₂ at temperatures of more than 1300° C.

A SiO_{0.70-0.99} layer is formed preferably by evaporating silicon monoxide containing silicon in an amount up to 20% by weight at temperatures of more than 1300° C.

The production of porous SiO_{z} flakes with z>1 can be achieved by providing additional oxygen during the evaporation. For this purpose the vacuum chamber can be provided with a gas inlet, by which the oxygen partial pressure in the vacuum chamber can be controlled to a constant value.

Alternatively, after drying, the product can be subjected to oxidative heat treatment. Known methods are available for that purpose. Air or some other oxygen-containing gas is passed through the plane-parallel structures of SiO_{z} wherein z is, depending on the vapor-deposition conditions, from 0.70, especially 1 to about 1.8, which are in the form of loose material or in a fluidised bed, at a temperature of more than 200° C., preferably more than 400° C. and especially from 500 to 1000° C. The product can then be brought to the desired particle size by means of grinding or air-sieving, wherein comminution of the fragments of film to pigment size can be effected, for example, by means of ultrasound or by mechanical means using high-speed stirrers in a liquid medium, or after drying the fragments in an air-jet mill having a rotary classifer.

Alternatively, after drying, the porous SiO_{y} , particles can be heated according to WO03/106569 in an oxygen-free atmosphere, i.e. an argon or helium atmosphere, or in a vacuum of less than 13 Pa (10⁻¹ Torr), at a temperature above 400° C., especially 400 to 1100° C., whereby porous silicon oxide flakes containing Si nanoparticles can be obtained.

It is assumed that by heating SiO_{z} particles in an oxygen-free atmosphere, SiO_{z} disproportionates in SiO₂ and Si:

SiO_{z}→(z/z+a)SiO_{z+a}+(1−z/z+a)Si

In this disproportion porous SiO_{z+a} flakes are formed, containing (1−(z/z+a))Si, wherein 0.70≦z≦2, especially 0.70≦z≦0.99 or 1≦z≦1.8, 0.0≦a≦1.30, and the sum z and a is equal or less than 2. SiO_{z+a} is an oxygen enriched silicon suboxide.

SiO_{z}→(z/2)SiO₂+(1−(z/2))Si

The porous SiO_{z} flakes should have a minimum thickness of 50 nm, to be processible. The maximum thickness is dependent on the desired application, but is in general in the range of from 150 to 500 nm. The porosity of the flakes ranges from 5 to 85%.

Incorporation of the polymer additive into the pores of the SiO_{z} flakes can be achieved by diffusion, precipitation, covalent bonding and/or ion exchange.

The SiO_{z} flakes comprising a polymer additive can be obtained by a method, which comprises

a) dispersing the SiO_{z} flakes in a solution or dispersion of the polymer additive, or adding the polymer additive to a dispersion of the SiO_{z} flakes,

b) optionally precipitating the polymer additive onto the SiO_{z} flakes, and

c) isolating the SiO_{z} flakes comprising the polymer additive.

Preference is given to a method, which comprises

a) adding the SiO_{z} flakes to a solution of the polymer additive,

b) optionally precipitating the polymer additive onto the SiO_{z} flakes, and

c) subsequently isolating the SiO_{z} flakes comprising the polymer additive.

Advantageously, the procedure is such that the polymer additive is first dissolved in a suitable solvent (I) and then the SiO_{z} flakes are dispersed in the resulting solution. It is, however, also possible, vice versa, for the SiO_{z} flakes first to be dispersed in the solvent (I) and then for the polymer additive to be added and dissolved.

Any solvent that is miscible with the first solvent and that so reduces the solubility of the polymer additive, that it is completely, or almost completely, deposited onto the substrate is suitable as solvent (II). In this instance, both inorganic solvents and also organic solvents come into consideration. Isolation of the loaded substrate can then be carried out in conventional manner, for example, by filtering off, washing and drying.

As solvent may be used for example water, an organic solvent or mixtures thereof. Typical organic solvents are alcohols, esters, ethers, ketones, aliphatic or aromatic hydrocarbons.

The amount of the polymer additive in the SiO_{z} flakes is generally 0.001 to 20.0 percent by weight, especially 0.01 to 10 percent by weight, very especially 0.1 to 10.0 percent by weight based on the weight of the SiO_{z} flakes.

The polymer additive suitable in the instant invention may serve for different purposes or uses. For example, the polymer additive is an organic polymer additive.

Under the term light stabilizers there are understood UV-absorbers, such as hydroxyphenyl benzotriazol UV-absorbers, hydroxyphenyl triazine UV-absorbers, hydroxybenzophenone UV-absorbers, oxalic anilide UV-absorbers and sterically hindered amine light stabilizers or mixtures thereof.

Generic and specific examples are given below. The hydroxybenzophenone is for example of formula I

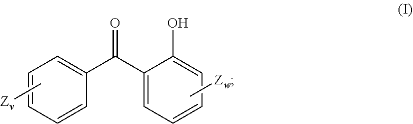

the 2-hydroxyphenylbenzotriazole is of for example formula IIa, IIb or IIc

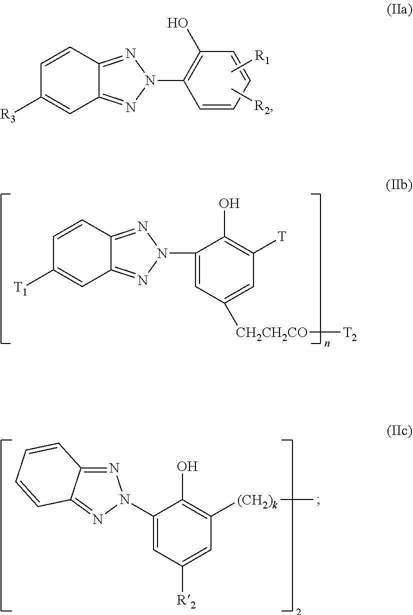

the 2-hydroxyphenyltriazine is for example of formula III

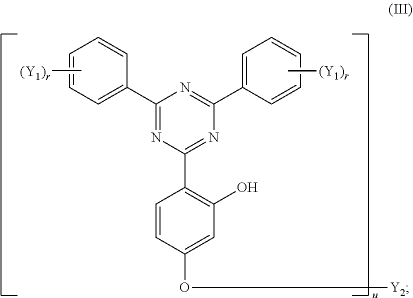

and the oxanilide is for example of formula (IV)

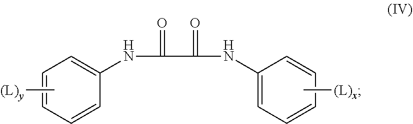

wherein

in the compounds of the formula (I) v is an integer from 1 to 3 and w is 1 or 2 and the substituents Z independently of one another are hydrogen, halogen, hydroxyl or alkoxy having 1 to 12 carbon atoms;

in the compounds of the formula (IIa),

R₁ is hydrogen, alkyl having 1 to 24 carbon atoms, phenylalkyl having 1 to 4 carbon atoms in the alkyl moiety, cycloalkyl having 5 to 8 carbon atoms or a radical of the formula

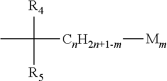

in which

R₄ and R₅ independently of one another are alkyl having in each case 1 to 5 carbon atoms, or R₄, together with the radical CₙH₂ₙ₊₁₋ₘ, forms a cycloalkyl radical having 5 to 12 carbon atoms,

m is 1 or 2, n is an integer from 2 to 20 and

M is a radical of the formula —COOR₆ in which

R₆ is hydrogen, alkyl having 1 to 12 carbon atoms, alkoxyalkyl having in each case 1 to 20 carbon atoms in the alkyl moiety and in the alkoxy moiety or phenylalkyl having 1 to 4 carbon atoms in the alkyl moiety,

R₂ is hydrogen, halogen, alkyl having 1 to 18 carbon atoms, and phenylalkyl having 1 to 4 carbon atoms in the alkyl moiety, and

R₃ is hydrogen, chlorine, alkyl or alkoxy having in each case 1 to 4 carbon atoms or —COOR₆ in which R₆ is as defined above, at least one of the radicals R₁ and R₂ being other than hydrogen;

in the compounds of the formula (IIb)

T is hydrogen or alkyl having 1 to 6 carbon atoms,

T₁ is hydrogen, chlorine or alkyl or alkoxy having in each case 1 to 4 carbon atoms,

n is 1 or 2 and,

if n is 1,

T₂ is chlorine or a radical of the formula —OT₃ or

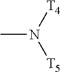

and,

if n is 2, T₂ is a radical of the formula

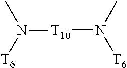

### or —O-T₉-O-;

in which

T₃ is hydrogen, alkyl which has 1 to 18 carbon atoms and is unsubstituted or substituted by 1 to 3 hydroxyl groups or by —OCOT₆, alkyl which has 3 to 18 carbon atoms, is interrupted once or several times by —O— or —NT₆- and is unsubstituted or substituted by hydroxyl or —OCOT₆, cycloalkyl which has 5 to 12 carbon atoms and is unsubstituted or substituted by hydroxyl and/or alkyl having 1 to 4 carbon atoms, alkenyl which has 2 to 18 carbon atoms and is unsubstituted or substituted by hydroxyl, phenylalkyl having 1 to 4 carbon atoms in the alkyl moiety, or a radical of the formula —CH₂CH(OH)-T₇ or

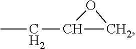

T₄ and T₅ independently of one another are hydrogen, alkyl having 1 to 18 carbon atoms, alkyl which has 3 to 18 carbon atoms and is interrupted once or several times by —O— or —NT₆-, cycloalkyl having 5 to 12 carbon atoms, phenyl, phenyl which is substituted by alkyl having 1 to 4 carbon atoms, alkenyl having 3 to 8 carbon atoms, phenylalkyl having 1 to 4 carbon atoms in the alkyl moiety or hydroxyalkyl having 2 to 4 carbon atoms,

T₆ is hydrogen, alkyl having 1 to 18 carbon atoms, cycloalkyl having 5 to 12 carbon atoms, alkenyl having 3 to 8 carbon atoms, phenyl, phenyl which is substituted by alkyl having 1 to 4 carbon atoms, phenylalkyl having 1 to 4 carbon atoms in the alkyl moiety,

T₇ is hydrogen, alkyl having 1 to 18 carbon atoms, phenyl which is unsubstituted or substituted by hydroxyl, phenylalkyl having 1 to 4 carbon atoms in the alkyl moiety, or —CH₂OT₈,

T₈ is alkyl having 1 to 18 carbon atoms, alkenyl having 3 to 8 carbon atoms, cycloalkyl having 5 to 10 carbon atoms, phenyl, phenyl which is substituted by alkyl having 1 to 4 carbon atoms, or phenylalkyl having 1 to 4 carbon atoms in the alkyl moiety,

T₉ is alkylene having 2 to 8 carbon atoms, alkenylene having 4 to 8 carbon atoms, alkynylene having 4 carbon atoms, cyclohexylene, alkylene which has 2 to 8 carbon atoms and is interrupted once or several times by —O—, or a radical of the formula —CH₂CH(OH)CH₂OT₁₁OCH₂CH(OH)CH₂— or —CH₂—C(CH₂OH)₂—CH₂—,

T₁₀ is alkylene which has 2 to 20 carbon atoms and can be interrupted once or several times by —O—, or cyclohexylene,

T₁₁ is alkylene having 2 to 8 carbon atoms, alkylene which has 2 to 18 carbon atoms and is interrupted once or several times by —O—, 1,3-cyclohexylene, 1,4-cyclohexylene, 1,3-phenylene or 1,4-phenylene, or

T₁₀ and T₆, together with the two nitrogen atoms, are a piperazine ring;

in the compounds of formula (IIc)

R′₂ is C₁-C₁₂alkyl and k is a number from 1 to 4;

in the compounds of the formula (III)

u is 1 or 2 and r is an integer from 1 to 3, the substituents

Y₁ independently of one another are hydrogen, hydroxyl, phenyl or halogen, halogenomethyl, alkyl having 1 to 12 carbon atoms, alkoxy having 1 to 18 carbon atoms, alkoxy having 1 to 18 carbon atoms which is substituted by a group —COO(C₁-C₁₈alkyl);

if u is 1,

Y₂ is alkyl having 1 to 18 carbon atoms, phenyl which is unsubstituted or substituted by hydroxyl, halogen, alkyl or alkoxy having 1 to 18 carbon atoms;

alkyl which has 1 to 12 carbon atoms and is substituted by —COON, —COOY₈, —CONH₂, —CONHY₉, —CONY₉Y₁₀, —NH₂, —NHY₉, —NY₉Y₁₀, —NHCOY₁₁, —CN and/or —OCOY₁₁;

alkyl which has 4 to 20 carbon atoms, is interrupted by one or more oxygen atoms and is unsubstituted or substituted by hydroxyl or alkoxy having 1 to 12 carbon atoms, alkenyl having 3 to 6 carbon atoms, glycidyl, cyclohexyl which is unsubstituted or substituted by hydroxyl, alkyl having 1 to 4 carbon atoms and/or —OCOY₁₁, phenylalkyl which has 1 to 5 carbon atoms in the alkyl moiety and is unsubstituted or substituted by hydroxyl, chlorine and/or methyl, —COY₁₂ or —SO₂Y₁₃, or,

if u is 2,

Y₂ is alkylene having 2 to 16 carbon atoms, alkenylene having 4 to 12 carbon atoms, xylylene, alkylene which has 3 to 20 carbon atoms, is interrupted by one or more —O— atoms and/or is substituted by hydroxyl, —CH₂CH(OH)CH₂—O—Y₁₉-OCH₂CH(OH)CH₂, —CO—Y₁₆—CO—, —CO—NH—Y₁₇—NH—CO— or —(CH₂)ₘ—CO₂—Y₁₈—OCO—(CH₂)ₘ, in which

m is 1, 2 or 3,

Y₈ is alkyl having 1 to 18 carbon atoms, alkenyl having 3 to 18 carbon atoms, alkyl which has 3 to 20 carbon atoms, is interrupted by one or more oxygen or sulfur atoms or —NT₆- and/or is substituted by hydroxyl, alkyl which has 1 to 4 carbon atoms and is substituted by —P(O)(OY₁₄)₂, —NY₉Y₁₀ or —OCOY₁₁ and/or hydroxyl, alkenyl having 3 to 18 carbon atoms, glycidyl, or phenylalkyl having 1 to 5 carbon atoms in the alkyl moiety,

Y₉ and Y₁₀ independently of one another are alkyl having 1 to 12 carbon atoms, alkoxyalkyl having 3 to 12 carbon atoms, dialkylaminoalkyl having 4 to 16 carbon atoms or cyclohexyl having 5 to 12 carbon atoms, or Y₉ and Y₁₀ together are alkylene, oxaalkylene or azaalkylene having in each case 3 to 9 carbon atoms,

Y₁₁ is alkyl having 1 to 18 carbon atoms, alkenyl having 2 to 18 carbon atoms or phenyl,

Y₁₂ is alkyl having 1 to 18 carbon atoms, alkenyl having 2 to 18 carbon atoms, phenyl, alkoxy having 1 to 12 carbon atoms, phenoxy, alkylamino having 1 to 12 carbon atoms or phenylamino,

Y₁₃ is alkyl having 1 to 18 carbon atoms, phenyl or alkylphenyl having 1 to 8 carbon atoms in the alkyl radical,

Y₁₄ is alkyl having 1 to 12 carbon atoms or phenyl,

Y₁₅ is alkylene having 2 to 10 carbon atoms, phenylene or a group -phenylene-M-phenylene- in which M is —O—, —S—, —SO₂—, —CH₂— or —C(CH₃)₂—,

Y₁₆ is alkylene, oxaalkylene or thiaalkylene having in each case 2 to 10 carbon atoms, phenylene or alkenylene having 2 to 6 carbon atoms,

Y₁₇ is alkylene having 2 to 10 carbon atoms, phenylene or alkylphenylene having 1 to 11 carbon atoms in the alkyl moiety, and

Y₁₈ is alkylene having 2 to 10 carbon atoms or alkylene which has 4 to 20 carbon atoms and is interrupted once or several times by oxygen;

in the compounds of the formula (IV) x is an integer from 1 to 3 and the substituents L independently of one another are hydrogen, alkyl, alkoxy or alkylthio having in each case 1 to 22 carbon atoms, phenoxy or phenylthio.

C₁-C₁₈alkyl may be linear or branched. Examples of alkyl having up to 18 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethyl-hexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

In the compounds of the formula (IIa) R₁ can be hydrogen or alkyl having 1 to 24 carbon atoms, such as methyl, ethyl, propyl, butyl, hexyl, octyl, nonyl, dodecyl, tetradecyl, hexadecyl, octadecyl, nonadecyl and eicosyl and also corresponding branched isomers. Furthermore, in addition to phenylalkyl having 1 to 4 carbon atoms in the alkyl moiety, for example benzyl, R₁ can also be cycloalkyl having 5 to 8 carbon atoms, for example cyclopentyl, cyclohexyl and cyclooctyl, or a radical of the formula

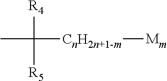

in

which R₄ and R₅ independently of one another are alkyl having in each case 1 to 5 carbon atoms, in particular methyl, or R₄, together with the CₙH₂ₙ₊₁₋ₘ radical, forms a cycloalkyl radical having 5 to 12 carbon atoms, for example cyclohexyl, cyclooctyl and cyclodecyl. M is a radical of the formula —COOR₆ in which R₆ is not only hydrogen but also alkyl having 1 to 12 carbon atoms or alkoxyalkyl having 1 to 20 carbon atoms in each of the alkyl and alkoxy moieties. Suitable alkyl radicals R₆ are those enumerated for R₁. Examples of suitable alkoxyalkyl groups are —C₂H₄OC₂H₅, —C₂H₄OC₈H₁₇ and —C₄H₈OC₄H₉. As phenylalkyl having 1 to 4 carbon atoms, R₆ is, for example, benzyl, cumyl, α-methylbenzyl or phenylbutyl.

In addition to hydrogen and halogen, for example chlorine and bromine, R₂ can also be alkyl having 1 to 18 carbon atoms. Examples of such alkyl radicals are indicated in the definitions of R₁. R₂ can also be phenylalkyl having 1 to 4 carbon atoms in the alkyl moiety, for example benzyl, a-methylbenzyl and cumyl.

Halogen as a substituent means in all cases fluorine, chlorine, bromine or iodine, preferably chlorine or bromine and more preferably chlorine.

At least one of the radicals R₁ and R₂ must be other than hydrogen.

In addition to hydrogen or chlorine, R₃ is also alkyl or alkoxy having in each case 1 to 4 carbon atoms, for example methyl, butyl, methoxy and ethoxy, and also —COOR₆.

In the compounds of the formula (IIb) T is hydrogen or alkyl having 1 to 6 carbon atoms, such as methyl and butyl, T₁ is not only hydrogen or chlorine, but also alkyl or alkoxy having in each case 1 to 4 carbon atoms, for example methyl, methoxy and butoxy, and, if n is 1, T₂ is chlorine or a radical of the formula —OT₃ or —NT₄T₅. T₃ is here hydrogen or alkyl having 1 to 18 carbon atoms (cf. the definition of R₁). These alkyl radicals can be substituted by 1 to 3 hydroxyl groups or by a radical —OCOT₆. Furthermore, T₃ can be alkyl having 3 to 18 carbon atoms (cf. the definition of R₁) which is interrupted once or several times by —O— or —NT₆- and is unsubstituted or substituted by hydroxyl or —OCOT₆. Examples of T₃ as cycloalkyl are cyclopentyl, cyclohexyl or cyclooctyl. T₃ can also be alkenyl having 2 to 18 carbon atoms. Suitable alkenyl radicals are derived from the alkyl radicals enumerated in the definitions of R₁. These alkenyl radicals can be substituted by hydroxyl. Examples of T₃ as phenylalkyl are benzyl, phenylethyl, cumyl, a-methylbenzyl or benzyl. T₃ can also be a radical of the formula —CH₂CH(OH)-T₇ or

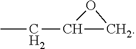

Like T₃, T₄ and T₅ can, independently of one another, be not only hydrogen but also alkyl having 1 to 18 carbon atoms or alkyl which has 3 to 18 carbon atoms and is interrupted once or several times by —O— or —NT₆-. T₄ and T₅ can also be cycloalkyl having 5 to 12 carbon atoms, for example cyclopentyl, cyclohexyl and cyclooctyl. Examples of T₄ and T₅ as alkenyl groups can be found in the illustrations of T₃. Examples of T₄ and T₅ as phenylalkyl having 1 to 4 carbon atoms in the alkyl moiety are benzyl or phenylbutyl. Finally, these substituents can also be hydroxyalkyl having 1 to 3 carbon atoms.

If n is 2, T₂ is a divalent radical of the formula

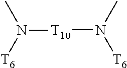

### or —O-T₉-O—.

In addition to hydrogen, T₆ (see above also) is alkyl, cycloalkyl, alkenyl, aryl or phenylalkyl; examples of such radicals have already been given above.

In addition to hydrogen and the phenylalkyl radicals and long-chain alkyl radicals mentioned above, T₇ can be phenyl or hydroxyphenyl and also —CH₂OT₆ in which T₉ can be one of the alkyl, alkenyl, cycloalkyl, aryl or phenylalkyl radicals enumerated.

The divalent radical T₉ can be alkylene having 2 to 8 carbon atoms, and such radicals can also be branched. This also applies to the alkenylene and alkynylene radicals T₉. As well as cyclohexylene, T₉ can also be a radical of the formula —CH₂CH(OH)CH₂OT₁₁OCH₂CH(OH)CH₂— or —CH₂—C(CH₂OH)₂—CH₂—.

T₁₀ is a divalent radical and, in addition to cyclohexylene, is also alkylene which has 2 to 20 carbon atoms and which can be interrupted once or several times by —O—. Suitable alkylene radicals are derived from the alkyl radicals mentioned in the definitions of R₁.

T₁₁ is also an alkylene radical. It contains 2 to 8 carbon atoms or, if it is interrupted once or several times by —O—, 4 to 10 carbon atoms. T₁₁ is also 1,3-cyclohexylene, 1,4-cyclohexylene, 1,3-phenylene or 1,4-phenylene.

Together with the two nitrogen atoms, T₆ and T₁₀ can also be a piperazine ring.

Examples of alkyl, alkoxy, phenylalkyl, alkylene, alkenylene, alkoxyalkyl and cycloalkyl radicals and also alkylthio, oxaalkylene or azoalkylene radicals in the compounds of the formulae (I), (IIa), (IIb), (IIc), (III) and IV) can be deduced from the above statements.

Within the benzotriazole UV-absorbers those according to formula IIa are in general preferred.

The UV absorbers of the formulae (I), (IIa), (IIb), (IIc), (III) and (IV) are known per se and are described, together with their preparation in, for example, WO 96/28431, EP-A-323 408, EP-A-57 160, U.S. Pat. No. 5,736,597 (EP-A-434 608), U.S. Pat. No. 4,619,956, DE-A 31 35 810 and GB-A 1 336 391. Preferred meanings of substituents and individual compounds can be deduced from the documents mentioned.

In another embodiment the UV-absorbers of the class of hydroxyphenyl triazines are of formula (IIIa)

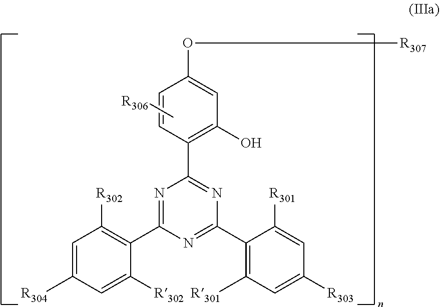

in which n is 1 or 2;

R₃₀₁, R′₃₀₁, R₃₀₂ and R′₃₀₂, independently of one another, are H, OH, C₁-C₁₂alkyl; C₂-C₆alkenyl; C₁-C₁₂alkoxy; C₂-C₁₈alkenoxy; halogen; trifluoromethyl; C₇-C₁₁phenylalkyl; phenyl; phenyl which is substituted by C₁-C₁₈alkyl, C₁-C₁₈alkoxy or halogen; phenoxy; or phenoxy which is substituted by C₁-C₁₈alkyl, C₁-C₁₈alkoxy or halogen;

R₃₀₃ and R₃₀₄, independently of one another, are H, C₁-C₁₂alkyl; OR′₃₀₇; C₂-C₆alkenyl; C₂-C₁₈alkenoxy; halogen; trifluoromethyl; C₇-C₁₁phenylalkyl; phenyl; phenyl which is substituted by C₁-C₁₈alkyl, C₁-C₁₈alkoxy or halogen; phenoxy; or phenoxy which is substituted by C₁-C₁₈alkyl, C₁-C₁₈alkoxy or halogen;

R₃₀₆ is hydrogen, C₁-C₂₄alkyl, C₅-C₁₂cycloalkyl or C₇-C₁₅phenylalkyl;

R₃₀₇, in the case where n=1, and R′₃₀₇, independently of one another, are hydrogen or C₁-C₁₈alkyl; or are C₁-C₁₂alkyl which is substituted by OH, C₁-C₁₈alkoxy, allyloxy, halogen, —COOH, —COOR₃₀₈, —CONH₂, —CONHR₃₀₉, —CON(R₃₀₉)(R₃₁₀), —NH₂, —NHR₃₀₉, —N(R₃₀₉)(R₃₁₀), —NHCOR₃₁₁, —CN, —OCOR₃₁₁, phenoxy and/or phenoxy which is substituted by C₁-C₁₈alkyl, C₁-C₁₈alkoxy or halogen; or R₃₀₇ is C₃-C₅₀alkyl which is interrupted by —O— and may be substituted by OH; or R₇ is C₃-C₆alkenyl; glycidyl; C₅-C₁₂cycloalkyl which is substituted by OH, C₁-C₄alkyl or —OCOR₃₁₁; C₇-C₁₁phenylalkyl which is unsubstituted or substituted by OH, Cl or CH₃; —CO—R₃₁₂ or —SO₂—R₃₁₃;

R₃₀₇, in the case where n=2, is C₂-C₁₆alkylene, C₄-C₁₂alkenylene, xylylene, C₃-C₂₀alkylene which is interrupted by O and/or substituted by OH, or is a group of the formula —CH₂CH(OH)CH₂O—R₃₂₀—OCH₂CH(OH)CH₂—, —CO—R₃₂₁—CO—, —CO—NH—R₃₂₂—NH—CO— or —(CH₂)ₘ—COO—R₃₂₃—OOC—(CH₂)ₘ—, in which m is a number in the range from 1 to 3, or is

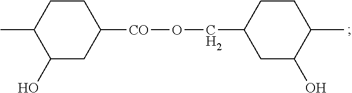

R₃₀₈ is C₁-C₁₈alkyl; C₂-C₁₀alkenyl; hydroxyethyl; C₃-C₅₀alkyl which is interrupted by O, NH, NR₃₀₉ or S and/or is substituted by OH; C₁-C₄alkyl which is substituted by —P(O)(OR₃₁₄)₂, —N(R₃₀₉)(R₃₁₀) or —OCOR₃₁₁ and/or OH; glycidyl; C₅-C₁₂cycloalkyl; phenyl; C₇-C₁₄alkylphenyl or C₇-C₁₁phenylalkyl;

R₃₀₉ and R₃₁₀, independently of one another, are C₁-C₁₂alkyl; C₃-C₁₂alkoxyalkyl; C₄-C₁₆dialkylaminoalkyl or C₅-C₁₂cycloalkyl, or R₃₀₉ and R₃₁₀ together are C₃-C₉alkylene or -oxaalkylene or -azaalkylene;

R₃₁₁ is C₁-C₁₈alkyl; C₂-C₁₈alkenyl or phenyl; C₂-C₁₂hydroxyalkyl; cyclohexyl; or is C₃-C₅₀alkyl which is interrupted by —O— and may be substituted by OH;

R₃₁₂ is C₁-C₁₈alkyl; C₂-C₁₈alkenyl; phenyl; C₁-C₁₈alkoxy; C₃-C₁₈alkenyloxy; C₃-C₅₀alkoxy which is interrupted by O, NH, NR₃₀₉ or S and/or substituted by OH; cyclohexyloxy; C₇-C₁₄alkylphenoxy; C₇-C₁₁phenylalkoxy; phenoxy; C₁-C₁₂alkylamino; phenylamino; tolylamino or naphthylamino;

R₃₁₃ is C₁-C₁₂alkyl; phenyl; naphthyl or C₇-C₁₄alkylphenyl;

R₃₁₄ is C₁-C₁₂alkyl, methylphenyl or phenyl;

R₃₂₀ is C₂-C₁₀alkylene; C₄-C₅₀alkylene which is interrupted by O, phenylene or a -phenylene-X-phenylene-group, in which X is —O—, —S—, —SO₂—, —CH₂— or —C(CH₃)₂—;

R₃₂₁ is C₂-C₁₀alkylene, C₂-C₁₀oxaalkylene, C₂-C₁₀thiaalkylene, C₆-C₁₂arylene or C₂-C₆alkenylene;

R₃₂₂ is C₂-C₁₀alkylene, phenylene, tolylene, diphenylenemethane or a

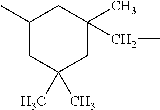

group; and

R₃₂₃ is C₂-C₁₀alkylene or C₄-C₂₀alkylene which is interrupted by O.

Halogen is in all cases fluorine, chlorine, bromine or iodine.

Examples of alkyl are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethyl-hexyl, 1,1,3-trimethylhexyl, 1,1,3,3-tetramethylpentyl, nonyl, decyl, undecyl, 1-methylundecyl, dodecyl.

Examples of alkoxy having up to 12 carbon atoms are methoxy, ethoxy, propoxy, isopropoxy, butoxy, isobutoxy, pentoxy, isopentoxy, hexoxy, heptoxy, octoxy, decyloxy, dodecyloxy.

Examples of alkenoxy are propenyloxy, butenyloxy, pentenyloxy and hexenyloxy.

Examples of C₅-C₁₂cycloalkyl are cyclopentyl, cyclohexyl, cycloheptyl, cyclooctyl and cyclo-dodecyl. C₅-C₈Cycloalkyl, especially cyclohexyl, is preferred.

C₁-C₄Alkyl-substituted C₅-C₁₂cycloalkyl is for example methylcyclohexyl or dimethyl-cyclohexyl.

OH— and/or C₁-C₁₀alkyl-substituted phenyl is for example methylphenyl, dimethylphenyl, trimethylphenyl, tert-butylphenyl or 3,5-di-tert-butyl-4-hydroxyphenyl.

Alkoxy-substituted phenyl is for example methoxyphenyl dimethoxyphenyl or trimethoxy-phenyl.

Examples of C₇-C₉phenylalkyl are benzyl and phenylethyl.

C₇-C₉Phenylalkyl which is substituted on the phenyl radical by —OH and/or by alkyl having up to 10 carbon atoms is for example methylbenzyl, dimethylbenzyl, trimethylbenzyl, tert-butylbenzyl or 3,5-di-tert-butyl-4-hydroxybenzyl.

Examples of alkenyl are allyl, 2-methallyl, butenyl, pentenyl and hexenyl. Allyl is preferred. The carbon atom in position 1 is preferably saturated.

Examples of alkylene are methylene, ethylene, propylene, trimethylene, tetramethylene, pentamethylene, 2,2-dimethyltrimethylene, hexamethylene, trimethylhexamethylene, octa-methylene and decamethylene.

Examples of alkenylene are butenylene, pentenylene and hexenylene.

C₆-C₁₂ arylene is preferably phenylene.

Alkyl interrupted by O is for example —CH₂—CH₂—O—CH₂—CH₃, —CH₂—CH₂—O—CH₃— or —CH₂—CH₂—O—CH₂—CH₂—CH₂—O—CH₂—CH₃—. It is preferably derived from polyethlene glycol. A general description is —((CH₂)ₐ—O)_{b}—H/CH₃, wherein a is a number from 1 to 6 and b is a number from 2 to 10.

C₂-C₁₀ oxaalkylene and C₂-C₁₀thiaalkylene can be deduced from the above mentioned alkylene groups by substituting one or more carbon atoms by an oxygen atom or a sulphur atom.

Specific examples of 2-hydroxybenzophenones are for example the 4-hydroxy, 4-methoxy, 4-octyloxy, 4-decyloxy, 4-dodecyloxy, 4-benzyloxy and 2′-hydroxy-4,4′-dimethoxy derivatives.

Specific examples of 2-(2′-hydroxyphenyl)benzotriazoles are for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

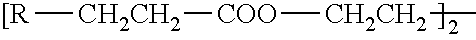

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetra-methylbutyl)-phenyl]benzotriazole; 2-[2′-hydroxy-3′-(1,1,3,3-tetramethylbutyl)-5′-(α,α-dimethylbenzyl)-phenyl]benzotriazole.

Specific examples of 2-(2-hydroxyphenyl)-1,3,5-triazines are for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-443-(2-ethylhexyl-1-oxy)-2-hydroxy-propyloxy]phenyl}-4,6-bis(2,4-dimethylphenyl)-1,3,5-triazine and 2-(2-hydroxy-4-(2-ethyl-hexyl)oxy)phenyl-4,6-di(4-phenyl)phenyl-1,3,5-triazine.

For instance the hydroxyphenyl-triazine UV-absorbers are of formulae:

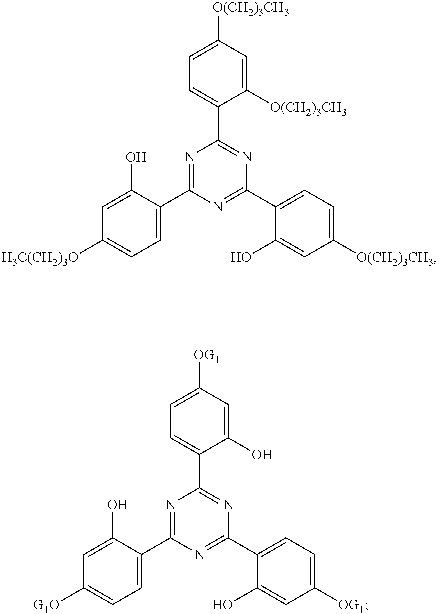

### G1=CH(CH₃)—COO—C₂H₅,

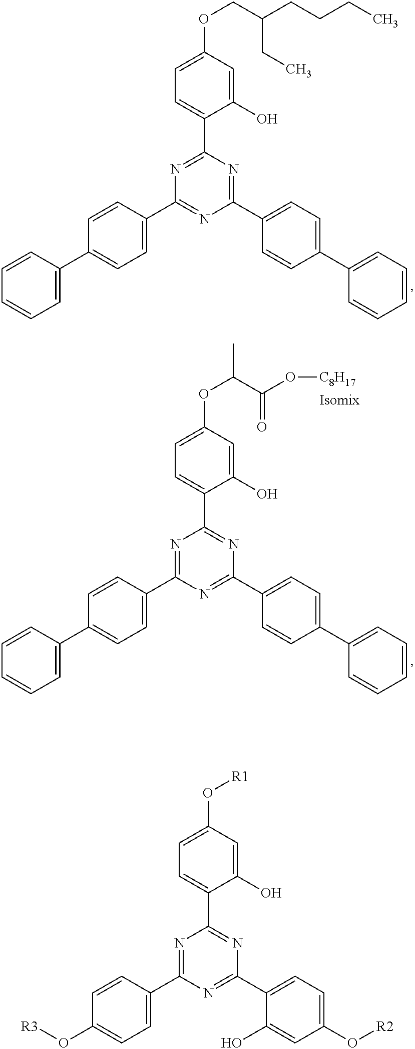

=a mixture of

a) R1=R2=CH(CH₃)—COO—C₈H₁₇, R3=R4=H;

b) R1=R2=R3=CH(CH₃)—COO—C₈H₁₇, R4=H;

c) R1=R2=R3=R4=CH(CH₃)—COO—C₈H₁₇,

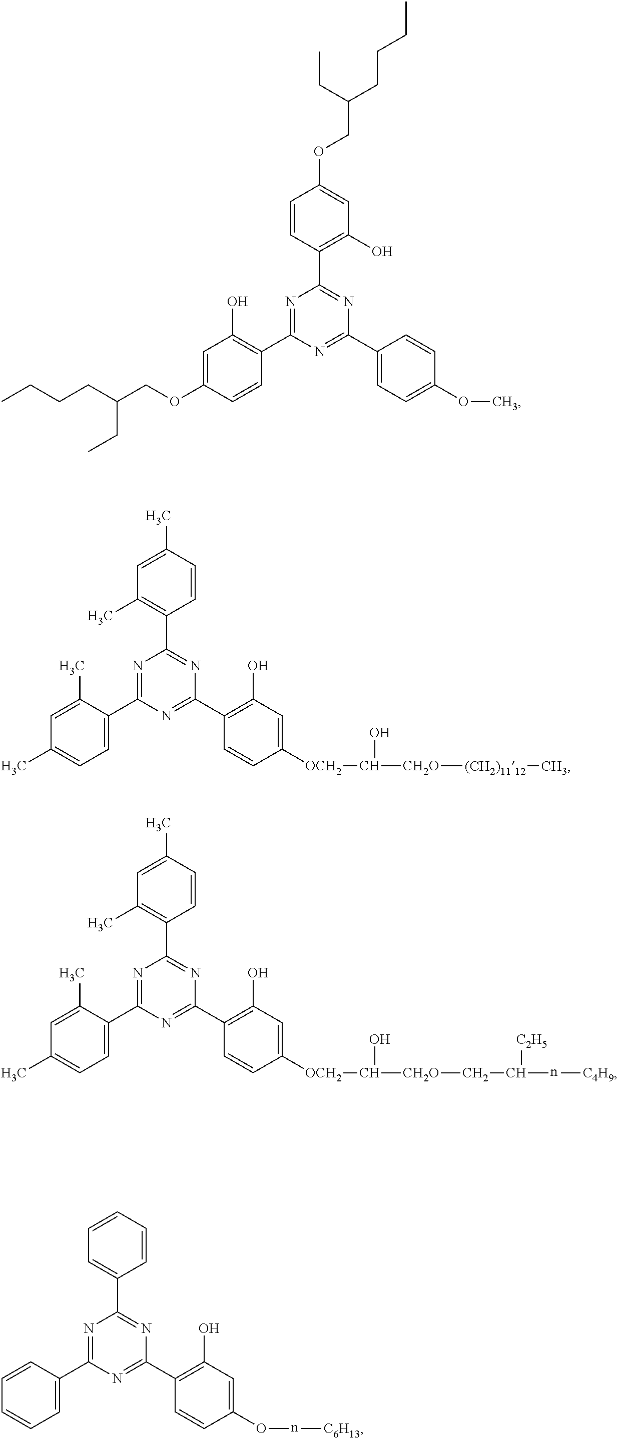

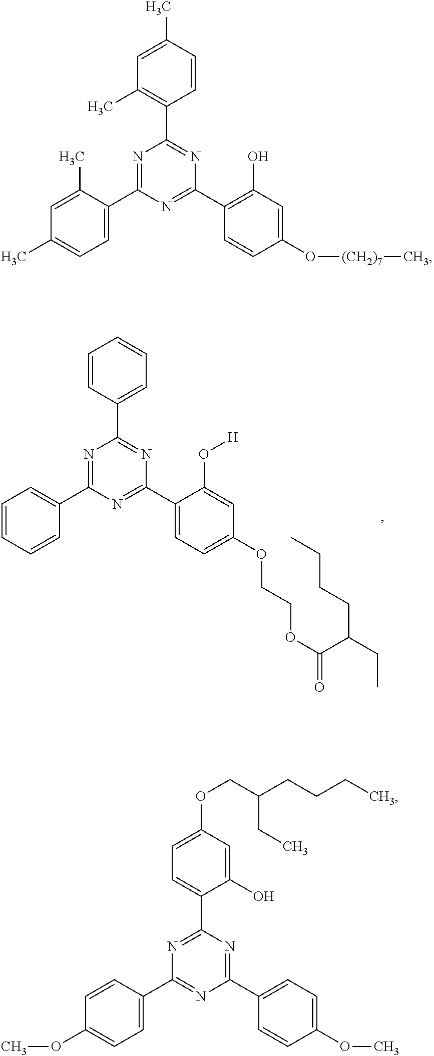

The hydroxyphenyl triazine UV-absorbers are known and partially items of commerce. They can be prepared according to the above documents.

Specific examples for oxamides are for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

The above mentioned UV-absorbers are largely items of commerce and for example known as Tinuvin® 109, 171, 326, 327, 328, 350, 360, 384, 400, 405, 411 or Chimassorb® 81 from Ciba Specialty Chemicals or Cyasorb® 1164 from Cytech Inc.

In many cases it may be of advantage to use a combination of UV-absorbers from different classes, such as for example a benzophenone UV-absorber with a benzotriazole UV-absorber or a hydroxyphenyltriazine UV-absorber with a benzotriazole UV-absorber. If such a combination is used, the weight ratio between both UV-absorbers is for example from 1:5 to 5:1, for instance from 1:3 to 3:1, particularly 1:1.5 to 1.5:1.

The sterically hindered amine contains at least one radical of the formula

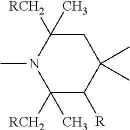

in which R is hydrogen or methyl.

The sterically hindered amine light stabilizer useful in the instant invention is preferably a compound of formulae (A-1) to (A-10) or of formulae (B-1) to (B-10);

(α-1) a compound of the formula (A-1)

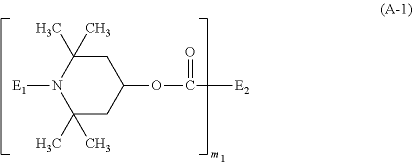

in which

E₁ is hydrogen, C₁-C₈alkyl, O⁻, —OH, —CH₂CN, C₁-C₁₈alkoxy, C₅-C₁₂cycloalkoxy, C₃-C₆alkenyl, C₇-C₅phenylalkyl unsubstituted or substituted on the phenyl by 1, 2 or 3 C₁-C₄alkyl; or C₁-C₈acyl,

mᵢ is 1, 2 or 4,

if m₁ is 1, E₂ is C₁-C₂₅alkyl,

if m₁ is 2, E₂ is C₁-C₁₄alkylene or a group of the formula (a-I)

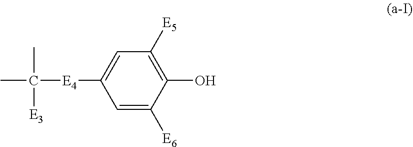

wherein E₃ is C₁-C₁₀alkyl or C₂-C₁₀alkenyl, E₄ is C₁-C₁₀alkylene, and

E₅ and E₆ independently of one another are C₁-C₄alkyl, cyclohexyl or methylcyclohexyl, and if m₁ is 4, E₂ is C₄-C₁₀alkanetetrayl;

(α-2) a compound of the formula (A-2)

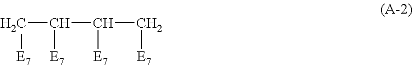

in which

two of the radicals E₇ are —COO—(C₁-C₂₀alkyl), and

two of the radicals E₇ are a group of the formula (a-II)

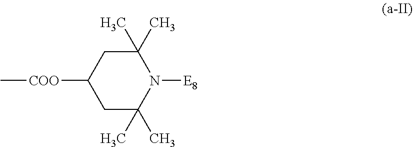

with E₈ having one of the meanings of E₁;

(α-3) a compound of the formula (A-3)

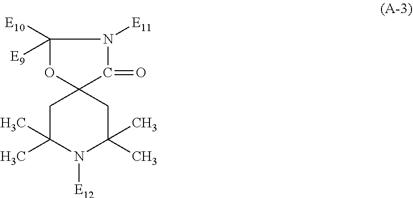

in which

E₉ and E₁₀ together form C₂-C₁₄alkylene,

E₁₁ is hydrogen or a group —Z₁—COOO—Z₂,

Z₁ is C₂-C₁₄alkylene, and

Z₂ is C₁-C₂₄alkyl, and

E₁₂ has one of the meanings of E₁;

(α-4) a compound of the formula (A-4)

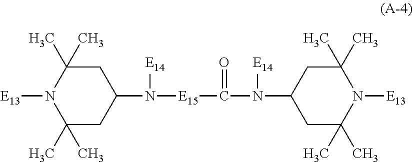

wherein

the radicals E₁₃ independently of one another have one of the meanings of E₁,

the radicals E₁₄ independently of one another are hydrogen or C₁-C₁₂alkyl, and

E₁₅ is C₁-C₁₀alkylene or C₃-C₁₀alkylidene;

(α-5) a compound of the formula (A-5)

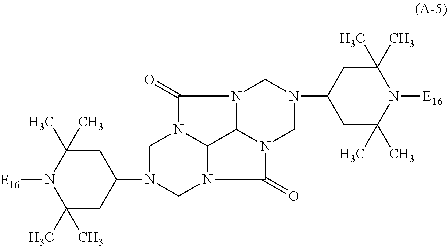

wherein

the radicals E₁₆ independently of one another have one of the meanings of E₁;

(α-6) a compound of the formula (A-6)

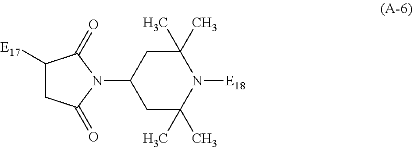

in which

E₁₇ is C₁-C₂₄alkyl, and

E₁₈ has one of the meanings of E₁;

(α-7) a compound of the formula (A-7)

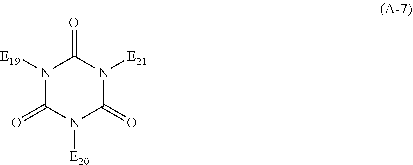

in which

E₁₉, E₂₀ and E₂₁ independently of one another are a group of the formula (a-III)

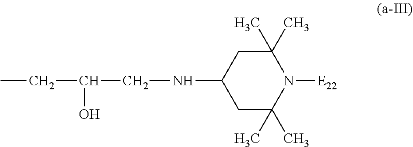

wherein E₂₂ has one of the meanings of E₁;

(α-8) a compound of the formula (A-8)

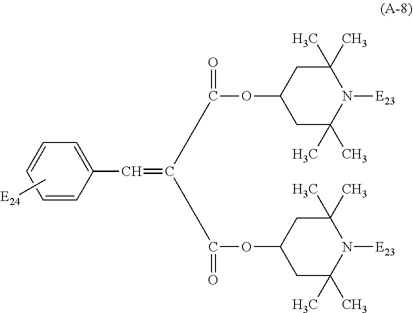

wherein

the radicals E₂₃ independently of one another have one of the meanings of E₁,

and E₂₄ is hydrogen, C₁-C₁₂alkyl or C₁-C₁₂alkoxy;

(α-9) a compound of the formula (A-9)

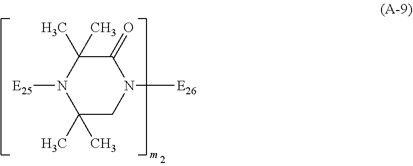

wherein

m₂ is 1, 2 or 3,

E₂₅ has one of the meanings of E₁, and

when m₂ is 1, E₂₆ is a group

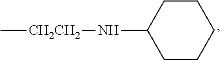

when m₂ is 2, E₂₆ is C₂-C₂₂alkylene, and

when m₂ is 3, E₂₆ is a group of the formula (a-IV)

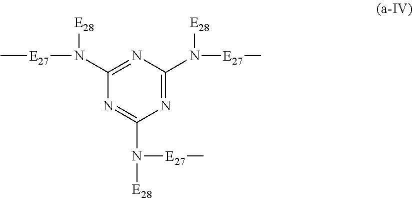

wherein the radicals E₂₇ independently of one another are C₂-C₁₂alkylene, and

the radicals E₂₈ independently of one another are C₁-C₁₂alkyl or C₉-C₁₂cycloalkyl;

(α-10) a compound of the formula (A-10)

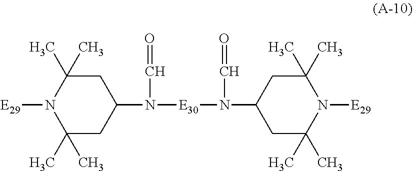

wherein

the radicals E₂₉ independently of one another have one of the meanings of E₁, and

E₃₀ is C₂-C₂₂alkylene, C₅-C₇cycloalkylene, C₁-C₄alkylenedi(C₅-C₇cycloalkylene), phenylene or phenylenedi(C₁-C₄alkylene);

(β-1) a compound of the formula (B-1)

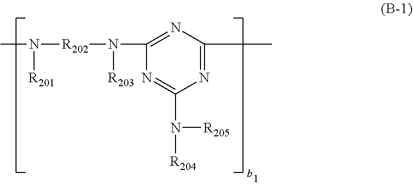

in which

R₂₀₁, R₂₀₃, R₂₀₄ and R₂₀₅ independently of one another are hydrogen, C₁-C₁₂alkyl, C₅-C₁₂cycloalkyl, C₁-C₄-alkyl-substituted C₅-C₁₂cycloalkyl, phenyl, phenyl which is substituted by —OH and/or C₁-C₁₀alkyl; C₇-C₉phenylalkyl, C₇-C₉phenylalkyl which is substituted on the phenyl radical by —OH and/or C₁-C₁₀alkyl; or a group of the formula (b-I)

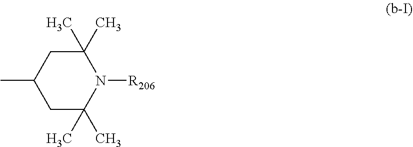

R₂₀₂ is C₂-C₁₈alkylene, C₅-C₇cycloalkylene or C₁-C₄alkylenedi(B₅-C₇cycloalkylene), or the radicals R₂₀₁, R₂₀₂ and R₂₀₃, together with the nitrogen atoms to which they are bonded, perform a 5- to 10-membered heterocyclic ring, or

R₂₀₄ and R₂₀₅, together with the nitrogen atom to which they are bonded, form a 5- to 10-membered heterocyclic ring,

R₂₀₈ is hydrogen, C₁-C₈alkyl, O⁻, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl, and

b₁ is a number from 2 to 50,

with the proviso that at least one of the radicals R₂₀₁, R₂₀₃, R₂₀₄ and R₂₀₅ is a group of the formula (b-I);

(β-2) a compound of the formula (B-2)

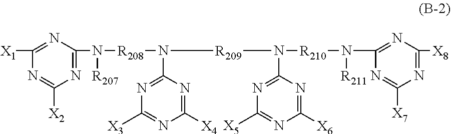

wherein

R₂₀₇ and R₂₁₁ independently of one another are hydrogen or C₁-C₁₂alkyl,

R₂₀₈, R₂₀₉ and R₂₁₀ independently of one another are C₂-C₁₀alkylene, and

X₁, X₂, X₃, X₄, X₅, X₆, X₇ and X₈ independently of one another are a group of the formula (b-II),

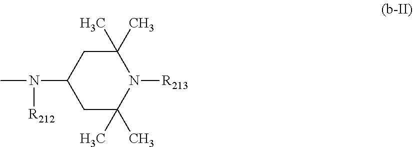

in which R₂₁₂ is hydrogen, C₁-C₁₂alkyl, C₅-C₁₂cycloalkyl, C₁-C₄alkyl-substituted

C₆-C₁₂cycloalkyl, phenyl, —OH— and/or C₁-C₁₀alkyl-substituted phenyl, C₇-C₉phenylalkyl,

C₇-C₉phenylalkyl which is substituted on the phenyl radical by —OH and/or C₁-C₁₀alkyl; or a group of the formula (b-I) as defined above, and

R₂₁₃ has one of the meanings of R₂₀₆;

(β-3) a compound of the formula (B-3)

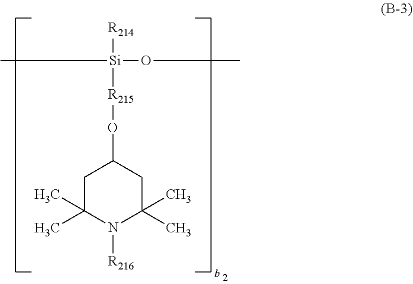

in which

R₂₁₄ is C₁-C₁₀alkyl, C₅-C₁₂cycloalkyl, C₁-C₄alkyl-substituted C₅-C₁₂cycloalkyl, phenyl or

C₁-C₁₀alkyl-substituted phenyl,

R₂₁₅ is C₃-C₁₀alkylene,

R₂₁₆ has one of the meanings of R₂₀₆, and

b₂ is a number from 2 to 50;

(β-4) a compound of the formula (B-4)

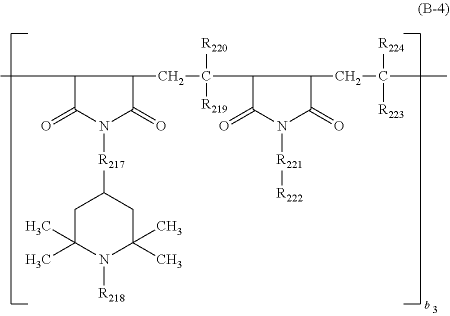

in which

R₂₁₇ and R₂₂₁ independently of one another are a direct bond or a —N(X₉)—CO—X₁₀—CO—N(X₁₁)-group, where X₉ and X₁₁ independently of one another are hydrogen, C₁-C₈alkyl, C₅-C₁₂cycloalkyl, phenyl, C₇-C₉phenylalkyl or a group of the formula (b-I),

X₁₀ is a direct bond or C₁-C₄alkylene,

R₂₁₈ has one of the meanings of R₂₀₆,

R₂₁₉, R₂₂₀, R₂₂₃ and R₂₂₄ independently of one another are hydrogen, C₁-C₃₀alkyl, C₅-C₁₂cycloalkyl or phenyl,

R₂₂₂ is hydrogen, C₁-C₃₀alkyl, C₅-C₁₂cycloalkyl, phenyl, C₇-C₉phenylalkyl or a group of the formula (b-I), and

b₃ is a number from 1 to 50;

(β-5) a compound of the formula (B-5)

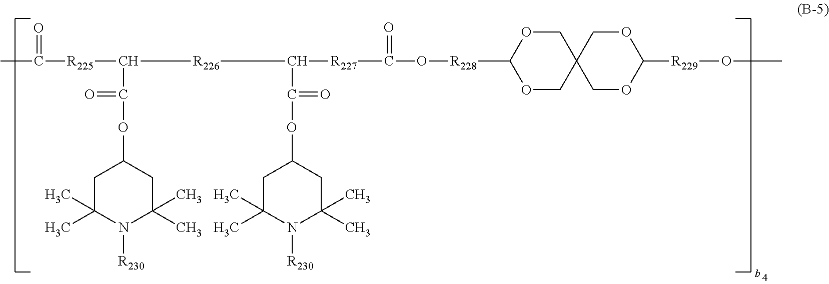

in which

R₂₂₅, R₂₂₆, R₂₂₇, R₂₂₈ and R₂₂₉ independently of one another are a direct bond or C₁-C₁₀alkylene,

R₂₃₀ has one of the meanings of R₂₀₆, and

b₄ is a number from 1 to 50;

(β-6) a product (B-6) obtainable by reacting a product, obtained by reaction of a polyamine of the formula (B-6-1) with cyanuric chloride, with a compound of the formula (B-6-2)

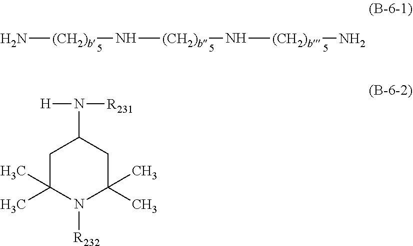

in which

b′₅, b″₅ and b′″₅ independently of one another are a number from 2 to 12,

R₂₃₁ is hydrogen, C₁-C₁₂alkyl, C₅-C₁₂cycloalkyl, phenyl or C₇-C₉phenylalkyl, and

R₂₃₂ has one of the meanings of R₂₀₆;

(β-7) a compound of the formula (B-7)

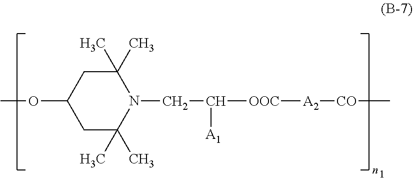

wherein A₁ is hydrogen or C₁-C₄alkyl,

A₂ is a direct bond or C₁-C₁₀alkylene, and

n₁ is a number from 2 to 50;

(β-8) at least one compound of the formulae (B-8-a) and (B-8-b)

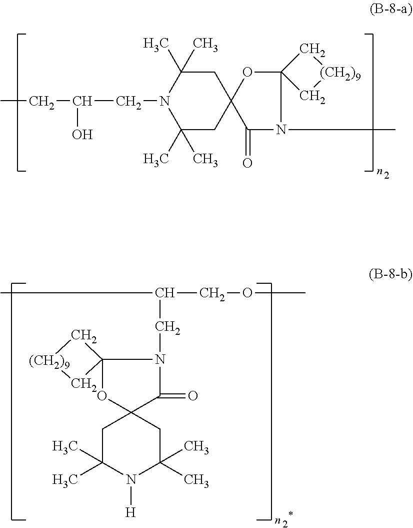

wherein n₂ and n₂* are a number from 2 to 50;

(β-9) a compound of the formula (B-9)

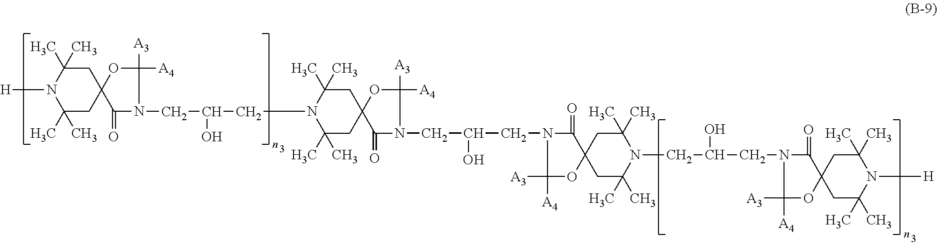

wherein A₃ and A₄ independently of one another are hydrogen or C₁-C₈alkyl, or A₃ and A₄ together form a C₂-C₁₄alkylene group, and

the variables n₃ independently of one another are a number from 1 to 50; and

(β-10) a compound of the formula (B-10)

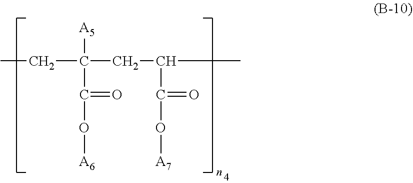

wherein n₄ is a number from 2 to 50,

A₅ is hydrogen or C₁-C₄alkyl,

the radicals A₆ and A₇ independently of one another are C₁-C₄alkyl or a group of the formula (b-I), with the proviso that at least 50% of the radicals A₇ are a group of the formula (b-I).

Examples of alkyl having up to 30 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethyl-butyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl, docosyl and triacontyl. One of the preferred definitions of E₁, E₈, E₁₂, E₁₃, E₁₆, E₁₈, E₂₂, E₂₃, E₂₅, E₂₉, R₂₀₆, R₂₁₃, R₂₁₆, R₂₁₈, R₂₃₀ and R₂₃₂ is C₁-C₄alkyl, especially methyl. R₂₃₁ is preferably butyl.

Examples of alkoxy having up to 18 carbon atoms are methoxy, ethoxy, propoxy, isopropoxy, butoxy, isobutoxy, pentoxy, isopentoxy, hexoxy, heptoxy, octoxy, decyloxy, dodecyloxy, tetradecyloxy, hexadecyloxy and octadecyloxy. One of the preferred meanings of E₁ is octoxy. E₂₄ is preferably C₁-C₄alkoxy and one of the preferred meanings of R₂₀₆ is propoxy.

Examples of C₅-C₁₂cycloalkyl are cyclopentyl, cyclohexyl, cycloheptyl, cyclooctyl and cyclododecyl. C₅-C₈Cycloalkyl, especially cyclohexyl, is preferred.

C₁-C₄Alkyl-substituted C₅-C₁₂cycloalkyl is for example methylcyclohexyl or dimethylcyclohexyl.

Examples of C₅-C₁₂cycloalkoxy are cyclopentoxy, cyclohexoxy, cycloheptoxy, cyclooctoxy, cyclodecyloxy and cyclododecyloxy. C₅-C₈Cycloalkoxy, in particular cyclopentoxy and cyclohexoxy, is preferred.

—OH— and/or C₁-C₁₀alkyl-substituted phenyl is for example methylphenyl, dimethylphenyl, trimethylphenyl, tert-butylphenyl or 3,5-di-tert-butyl-4-hydroxyphenyl.

Examples of C₇-C₉phenylalkyl are benzyl and phenylethyl.

C₇-C₉Phenylalkyl which is substituted on the phenyl radical by —OH and/or by alkyl having up to 10 carbon atoms is for example methylbenzyl, dimethylbenzyl, trimethylbenzyl, tert-butylbenzyl or 3,5-di-tert-butyl-4-hydroxybenzyl.

Examples of alkenyl having up to 10 carbon atoms are allyl, 2-methallyl, butenyl, pentenyl and hexenyl. Allyl is preferred. The carbon atom in position 1 is preferably saturated.

Examples of acyl containing not more than 8 carbon atoms are formyl, acetyl, propionyl, butyryl, pentanoyl, hexanoyl, heptanoyl, octanoyl, acryloyl, methacryloyl and benzoyl. C₁-C₈Alkanoyl, C₃-C₈alkenyl and benzoyl are preferred. Acetyl and acryloyl are especially preferred.

Examples of alkylene having up to 22 carbon atoms are methylene, ethylene, propylene, trimethylene, tetramethylene, pentamethylene, 2,2-dimethyltrimethylene, hexamethylene, trimethylhexamethylene, octamethylene and decamethylene.

An example of C₃-C₁₀alkylidene is the group

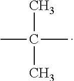

An example of C₄-C₁₀alkanetetrayl is 1,2,3,4-butanetetrayl.

An example of C₅-C₇cycloalkylene is cyclohexylene.

An example of C₁-C₄alkylenedi(C₅-C₇cycloalkylene) is methylenedicyclohexylene.

An example of phenylenedi(C₁-C₄alkylene) is methylene-phenylene-methylene or ethylene-phenylene-ethylene.

Where the radicals R₂₀₁, R₂₀₂ and R₂₀₃, together with the nitrogen atoms to which they are attached, form a 5- to 10-membered heterocyclic ring, this ring is for example

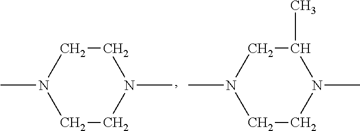

A 6-membered heterocyclic ring is preferred.

Where the radicals R₂₀₄ and R₂₀₅, together with the nitrogen atom to which they are attached, form a 5- to 10-membered heterocyclic ring, this ring is for example 1-pyrrolidyl, piperidino, morpholino, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl. Morpholino is particularly preferred.

One of the preferred definitions of R₂₁₉ and R₂₂₃ is phenyl.

R₂₂₆ is preferably a direct bond.

n₁, n₂, n₂* and n₄ are preferably a number from 2 to 25, in particular 2 to 20.

n₃ is preferably a number from 1 to 25, in particular 1 to 20.

b₁ and b₂ are preferably a number from 2 to 25, in particular 2 to 20.

b₃ and b₄ are preferably a number from 1 to 25, in particular 1 to 20.

b′₅ and b′″₅ are preferably 3 and b″₅ is preferably 2.

The compounds described above are essentially known and commercially available. All of them can be prepared by known processes.

The preparation of the compounds is disclosed, for example, in

U.S. Pat. No. 5,679,733, U.S. Pat. No. 3,640,928, U.S. Pat. No. 4,198,334, U.S. Pat. No. 5,204,473, U.S. Pat. No. 4,619,958, U.S. Pat. No. 4,110,306, U.S. Pat. No. 4,110,334, U.S. Pat. No. 4,689,416, U.S. Pat. No. 4,408,051, SU-A-768,175 (Derwent 88-138,751/20), U.S. Pat. No. 5,049,604, U.S. Pat. No. 4,769,457, U.S. Pat. No. 4,356,307, U.S. Pat. No. 4,619,956, U.S. Pat. No. 5,182,390, GB-A-2,269,819, U.S. Pat. No. 4,292,240, U.S. Pat. No. 5,026,849, U.S. Pat. No. 5,071,981, U.S. Pat. No. 4,547,538, U.S. Pat. No. 4,976,889, U.S. Pat. No. 4,086,204, U.S. Pat. No. 6,046,304, U.S. Pat. No. 4,331,586, U.S. Pat. No. 4,108,829, U.S. Pat. No. 5,051,458, WO-A-94/12,544 (Derwent 94-177,274/22), DD-A-262,439 (Derwent 89-122,983/17), U.S. Pat. No. 4,857,595, U.S. Pat. No. 4,529,760 , U.S. Pat. No. 4,477,615 , CAS 136,504-96-6, U.S. Pat. No. 4,233,412, U.S. Pat. No. 4,340,534, WO-A-98/51,690 and EP-A-1,803.

The product (B-6) can be prepared analogously to known processes, for example by reacting a polyamine of formula (B-6-1) with cyanuric chloride in a molar ratio of from 1:2 to 1:4 in the presence of anhydrous lithium carbonate, sodium carbonate or potassium carbonate in an organic solvent such as 1,2-dichloroethane, toluene, xylene, benzene, dioxane or tert-amyl alcohol at a temperature of from −20° C. to +10° C., preferably from −10° C. to +10° C., in particular from 0° C. to +10° C., for from 2 to 8 hours, followed by reaction of the resultant product with a 2,2,6,6-tetramethyl-4-piperidylamine of the formula (B-6-2). The molar ratio of the 2,2,6,6-tetramethyl-4-piperidylamine to polyamine of the formula (B-6-1) employed is for example from 4:1 to 8:1. The quantity of the 2,2,6,6-tetramethyl-4-piperidylamine can be added in one portion or in more than one portion at intervals of a few hours.

The molar ratio of polyamine of the formula (B-6-1) to cyanuric chloride to 2,2,6,6-tetramethyl-4-piperidylamine of the formula (B-6-2) is preferably from 1:3:5 to 1:3:6.

The following example indicates one way of preparing a preferred product (B-6-a).

Example: 23.6 g (0.128 mol) of cyanuric chloride, 7.43 g (0.0426 mol) of N,N′-bis[3-aminopropyl]ethylenediannine and 18 g (0.13 mol) of anhydrous potassium carbonate are reacted at 5° C. for 3 hours with stirring in 250 ml of 1,2-dichloroethane. The mixture is warmed at room temperature for a further 4 hours. 27.2 g (0.128 mol) of N-(2,2,6,6-tetramethyl-4-piperidyl)butylamine are added and the resultant mixture is warmed at 60° C. for 2 hours. A further 18 g (0.13 mol) of anhydrous potassium carbonate are added and the mixture is warmed at 60° C. for a further 6 hours. The solvent is removed by distillation under a slight vacuum (200 mbar) and replaced by xylene. 18.2 g (0.085 mol) of N-(2,2,6,6-tetra-methyl-4-piperidyl)butylamine and 5.2 g (0.13 mol) of ground sodium hydroxide are added, the mixture is heated at reflux for 2 hours and, for a further 12 hours, the water formed during the reaction is removed by azeotropic distillation. The mixture is filtered. The solution is washed with water and dried over Na₂SO₄. The solvent is evaporated and the residue is dried at 120-130° C. in vacuo (0.1 mbar). The desired product is obtained as a colourless resin.

In general, the product (B-6) can, for example, be represented by a compound of the formula (B-6-α), (B-6-β) or (B-6-γ). It can also be in the form of a mixture of these three compounds.

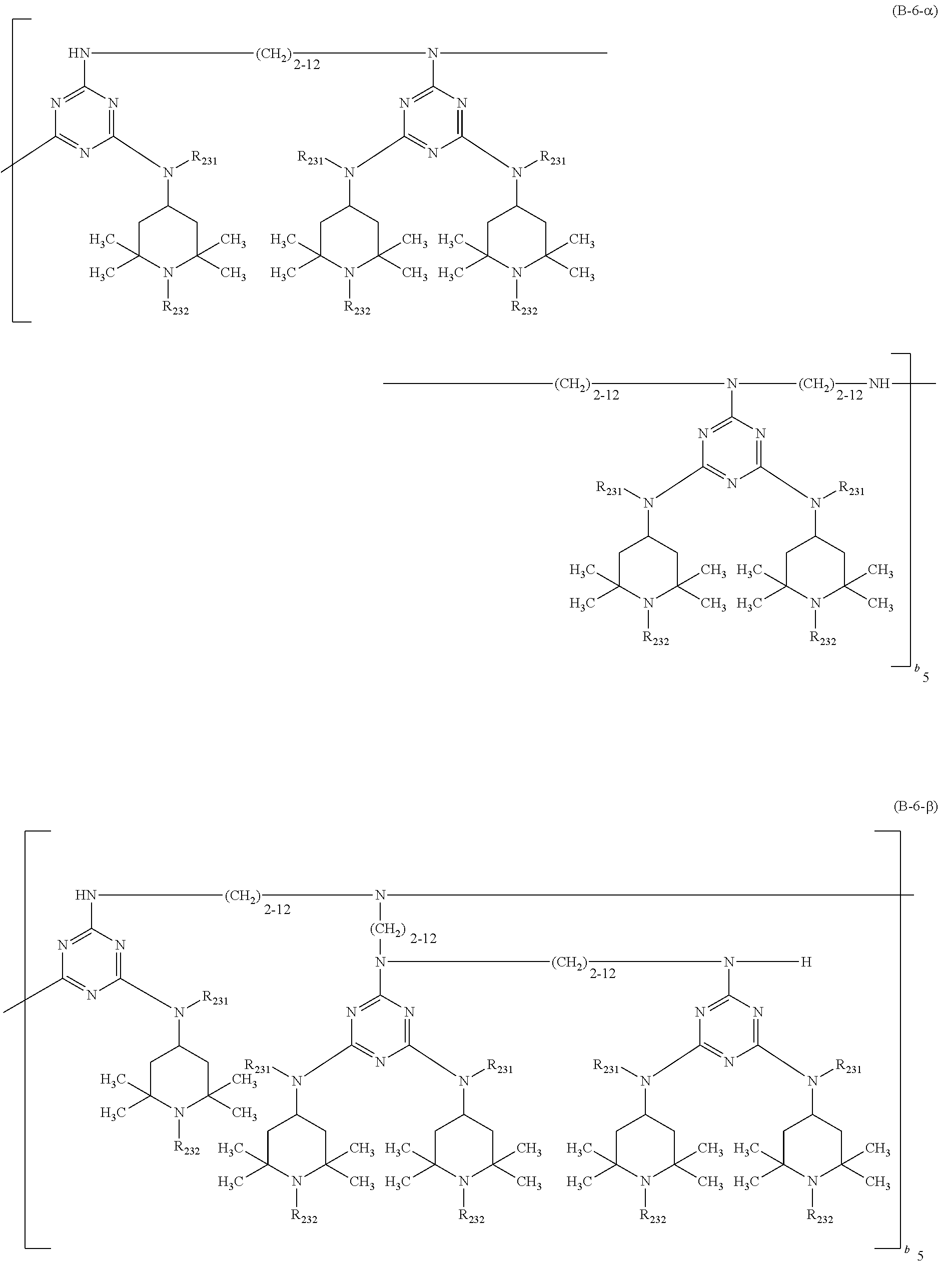

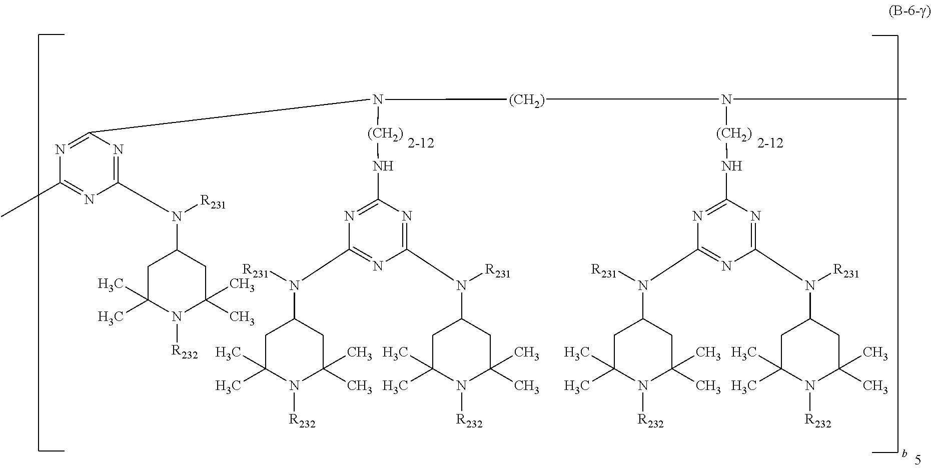

A preferred meaning of the formula (B-6-α) is

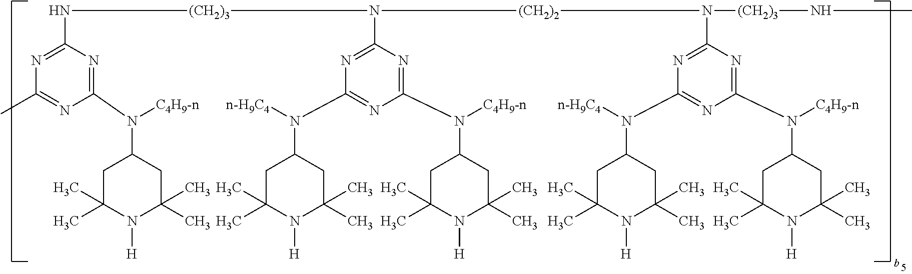

A preferred meaning of the formula (B-6-β) is

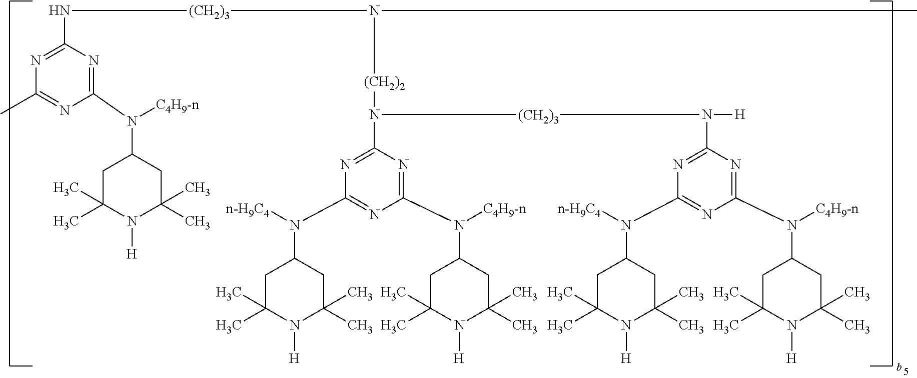

A preferred meaning of the formula (B-6-γ) is

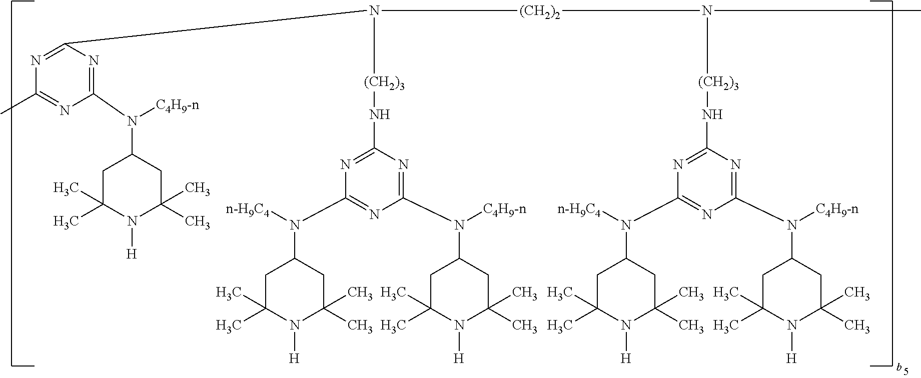

In the above formulae (B-6-α) to (B-6-γ), b₅ is preferably 2 to 20, in particular 2 to 10.

The sterically hindered amine compounds of component (c) are preferably selected from the group consisting of the following commercial products:

DASTIB 845®, TINUVIN 770®, TINUVIN NOR 371®, TINUVIN 765®, TINUVIN 144®, TINUVIN 123®, TINUVIN 111®, TINUVIN 783®, TINUVIN 791®, MARK LA 52®, MARK LA 57®, MARK LA 62®, MARK LA 67®, HOSTAVIN N 20®, HOSTAVIN N 24®, SANDUVOR 3050®, SANDUVOR 3053®, SANDUVOR 3058®, DIACETAM 5®, SUMISORB TM 61®, UVINUL 4049®, SANDUVOR PR 31®, GOODRITE UV 3034®, GOODRITE UV 3150®, GOODRITE UV 3159®, GOODRITE 3110 x 128®, UVINUL 4050 H®, CHIMASSORB 944®, CHIMASSORB 2020®, CYASORB UV 3346®, CYASORB UV 3529®, DASTIB 1082®, CHIMASSORB 119®, UVASIL 299®, UVASIL 125®, UVASIL 2000®, UVINUL 5050 H®, LICHTSCHUTZSTOFF UV 31®, LUCHEM HA B 18®, MARK LA 63®, MARK LA 68®, UVASORB HA 88®, TINUVIN 622®, HOSTAVIN N 30® and FERRO AM 806 ®.

Particularly preferred are TINUVIN 770®, TINUVIN NOR 371®, TINUVIN 791®, TINUVIN 622®, TINUVIN 783®, CHIMASSORB 944®, CHIMASSORB 2020® and CHIMASSORB 119 ®.

Most preferred are Tinuvin 770®, TUNIVIN 292®, TINUVIN 123®, TINUVIN 152®, TINUVIN NOR 371® and TINUVIN 791 ®.

The meanings of the terminal groups which saturate the free valences in the compounds of the formulae (B-1), (B-3), (B-4), (B-5), (B-6-α), (B-6-β), (B-6-γ), (B-7), (B-8-a), (B-8-b) and B-10) depend on the processes used for their preparation. The terminal groups can also be modified after the preparation of the compounds.

If the compounds of the formula (B-1) are prepared by reacting a compound of the formula

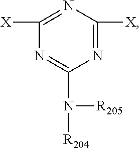

in which X is, for example, halogen, in particular chlorine, and R₂₀₄ and R₂₀₅ are as defined above, with a compound of the formula

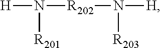

in which R₂₀₁, R₂₀₂ and R₂₀₃ are as defined above, the terminal group bonded to the diamino radical is hydrogen or

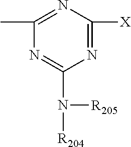

and the terminal group bonded to the triazine radical is X or

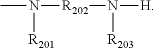

If X is halogen, it is advantageous to replace this, for example, by —OH or an amino group when the reaction is complete. Examples of amino groups which may be mentioned are pyrrolidin-1-yl, morpholino, —NH₂, —N(C₁-C₈)alkyl)₂ and —NR(C₁-C₈alkyl), in which R is hydrogen or a group of the formula (b-I).

The compounds of the formula (B-1) also cover compounds of the formula

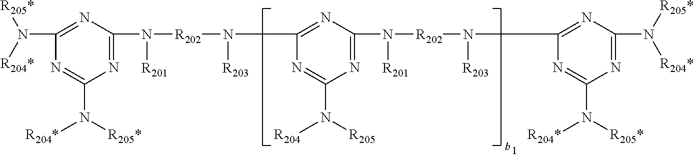

wherein R₂₀₁, R₂₀₂, R₂₀₃, R₂₀₄, R₂₀₅ and b₁ are as defined above and R₂₀₄* has one of the meanings of R₂₀₄ and R₂₀₅* has one of the meanings of R₂₀₅.

One of the particularly preferred compounds of the formula (B-1) is

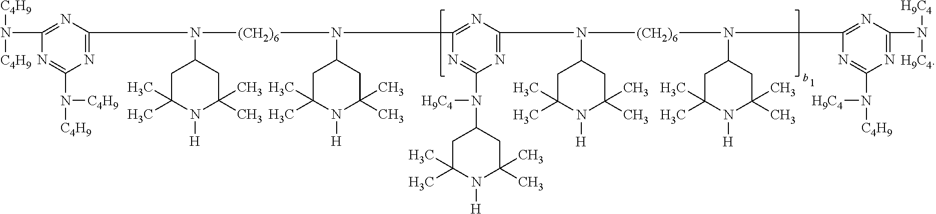

The preparation of this compound is described in Example 10 of U.S. Pat. No. 6,046,304.

In the compounds of the formula (B-3), the terminal group bonded to the silicon atom can be, for example, (R₁₄)₃Si—O—, and the terminal group bonded to the oxygen can be, for example, —Si(R₁₄)₃.

The compounds of the formula (B-3) can also be in the form of cyclic compounds if b₂ is a number from 3 to 10, i.e. the free valences shown in the structural formula then form a direct bond.

In the compounds of the formula (B-4), the terminal group bonded to the 2,5-dioxopyrrolidine ring is, for example, hydrogen, and the terminal group bonded to the —C(R₂₂₃)(R₂₂₄)— radical is, for example,

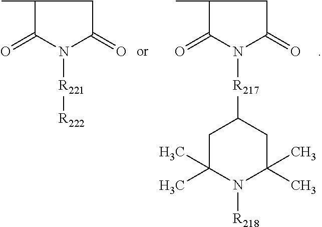

In the compounds of the formula (B-5), the terminal group bonded to the carbonyl radical is, for example,

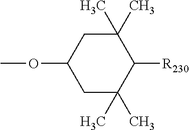

and the terminal group bonded to the oxygen radical is, for example,

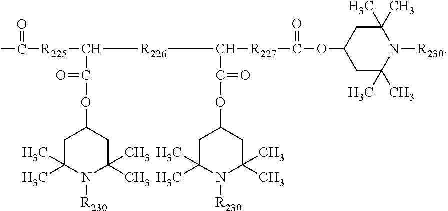

In the compounds of the formulae (B-6-α), (B-6-β) and (B-6-γ), the terminal group bonded to the triazine radical is, for example, Cl or a

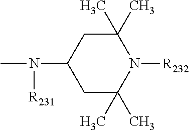

group, and the terminal group bonded to the amino radical is, for example, hydrogen or a

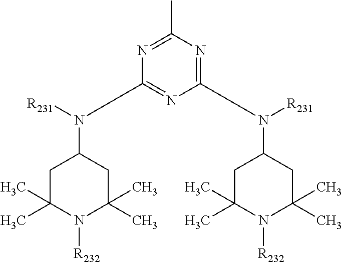

group.

If the compounds of the formula (B-7) are prepared, for example, by reacting a compound of the formula

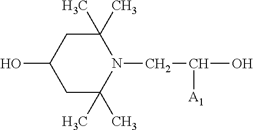

in which A₁ is hydrogen or methyl, with a dicarboxylic acid diester of the formula Y—OOC-A₂-COO—Y, in which Y is, for example, methyl, ethyl or propyl, and A₂ is as defined above, the terminal group bonded to the 2,2,6,6-tetramethyl-4-oxypiperidin-1-yl radical is hydrogen or —CO-A₂-COO—Y, and the terminal group bonded to the diacyl radical is —O—Y or

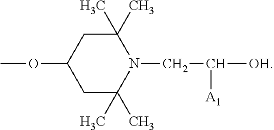

In the compounds of the formula (B-8-a), the terminal group bonded to the nitrogen can be, for example, hydrogen and the terminal group bonded to the 2-hydroxypropylene radical can be, for example, a

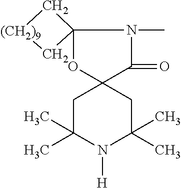

group.

In the compounds of the formula (B-8-b), the terminal group bonded to the dimethylene radical can be, for example, —OH, and the terminal group bonded to the oxygen can be, for example, hydrogen. The terminal groups can also be polyether radicals.

In the compounds of the formula (B-10), the end group bonded to the —CH₂— residue can be, for example, hydrogen and the end group bonded to the —CH(CO₂A₇) residue can be, for example, —CH═CH—COOA₇.

Specific examples for the sterically hindered amines are bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]-decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediannine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane and reaction product of maleic acid anhydride-α-olefin-copolymer with 2,2,6,6-tetramethyl-4-aminopiperidine, 1,2,2,6,6-pentamethyl-4-aminopiperidine, 2,4-bis[N-(1-cyclohexyloxy-2,2,6,6-tetramethylpiperidine-4-yl)-N-butyl-amino]-6-(2-hydroxyethyl)-amino-1,3,5-triazine, 1-(2-Hydroxy-2-methylpropoxy)-4-octadecanoyloxy-2,2,6,6-tetramethyl-piperidine, 5-(2-ethylhexanoyl)oxymethyl-3,3,5-trimethyl-2-morpholinone or a compound

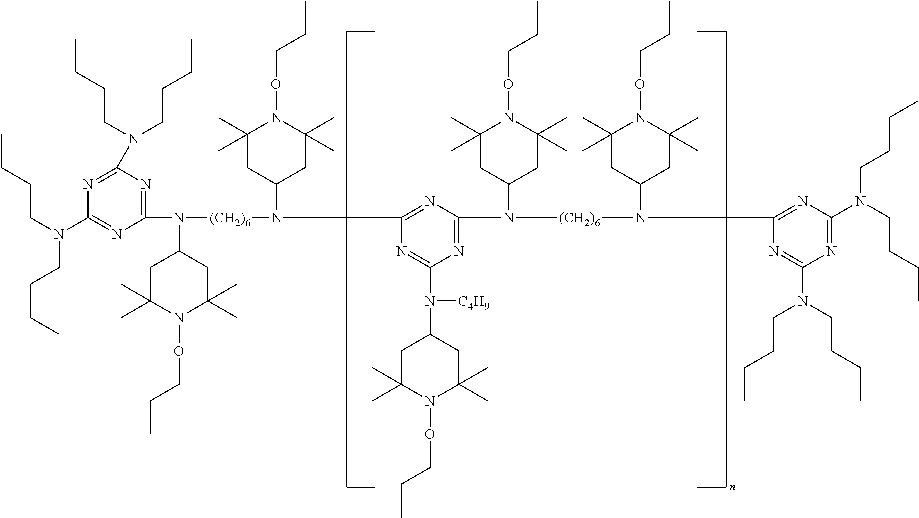

in which n is from 1 to 15, disclosed in example 2 of U.S. Pat. No. 6,117,995.

The sterically hindered amines mentioned above are known and are largely items of commerce.

Under the term heat and process stabilizers there is understood, for example antioxidants, phosphites and lactones. Examples and further classes of heat and processing stabilizers are given below.

1. Antioxidants 1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1¹-yl)phenol, 2,4-dimethyl-6(1′methylheptadec-1′-yl)phenol, 2,4-dimethyl-6-(1-methyltridec-1′-yl)phenol and mixtures thereof.

1.2. Alkylthiomethylphenols, for example 2,4-dioctylthiomethyl-6-tert-butylphenol, 2,4-dioctyl-thiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl)adipate.

1.4. Tocopherols, for example α-tocopherol, β-tocopherol, γ-tocopherol, 5-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydrdrooxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopenta-diene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O—, N— and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis-(3,5-di-tert-butyl-2-hydambenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydambenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydromhenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)-isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)-isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenylpropionyl acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of 8-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyphydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene, N,N-bis(2,2,6,6-tetra-methylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. Metal deactivators, for example N,N′-diphenyloxamide, N-salicylal-N′-salicyloyl hydrazine, N,N′-bis(salicyloyl)-hydrazine, N,N′-bis(3,5-di-tert-butyl-4-hydroxyphenylpropionyl)-hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyldihydrazide, N,N′-bis(salicyloyl)thiopropionyl dihydrazide.

3. Phosphites and phosphonites, for example triphenyl phosphite, diphenyl-alkyl phosphites, phenyl-dialkyl phosphites, tris(nonylphenyl) phosphite, trilauryl phosphite, trioctadecyl phosphite, distearyl-pentaerythritol diphosphite, tris(2,4-di-tert-butylphenyl) phosphite, diisodecyl pentaerythritol diphosphite, bis(2,4-di-tert-butylphenyl)-pentaerythritol diphosphite, bis(2,4-dicumylphenyl)-pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)-methyl phosphite, bis(2,4-di-tert-butyl-6-methylphenyl)-ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′, 5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The preferred arc the following phosphites are especially preferred:

Tris(2,4-di-tert-butylphenyl) phosphite (Irgafos® 168, Ciba-Geigy), tris(nonylphenyl) phosphite,

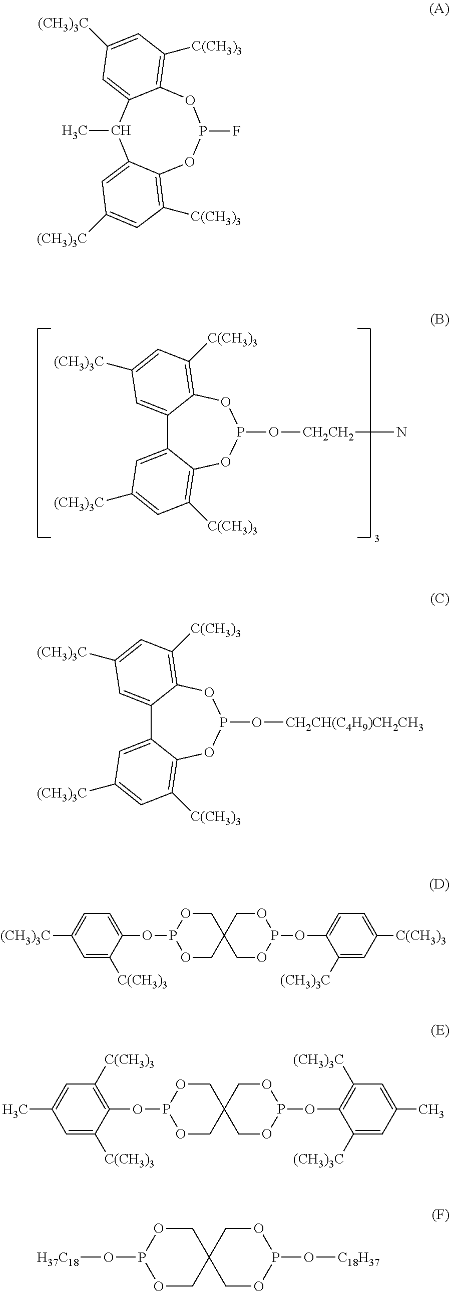

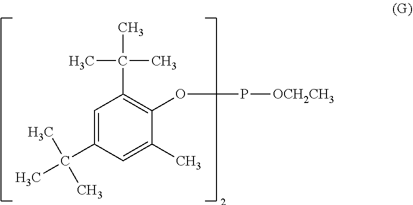

4. Hydroxylamines, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

5. Nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridecyl-nitrone, N-hexadecyl-alpha-pentadecyl-nitrone, N-octadecyl-alpha-heptadecyl-nitrone, N-hexadecyl-alpha-heptadecyl-nitrone, N-ocatadecyl-alpha-pentadecyl-nitrone, N-heptadecyl-alpha-heptadecyl-nitrone, N-octadecyl-alpha-hexadecyl-nitrone, nitrone derived from N, N-dialkylhydroxylamine derived from hydrogenated tallow amine.

6. Thiosynergists, for example, dilauryl thiodipropionate or distearyl thiodipropionate.

7. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis((3-dodecylmercapto)propionate.

8. Polyamide stabilisers, for example, copper salts in combination with iodides and/or phosphorus compounds and salts of divalent manganese.

9. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzo-furan-2-one, 3-(3,4-dimethylphenyl)-5,7-di-tert-butylbenzofuran-2-one, 3-(2,3-dimethylphenyl)-5,7-di-tert-butylbenzofuran-2-one.

Under the term acid scavenger there is understood melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate. A detailed description is given in Plastics Additives Handbook, 5th Edition 2001, Hans Zweifel Ed., Hanser (Hanser Publisher Munich, Hanser Gardner Publications, Inc. Cincinnati ISBN 3-446-21654-5, pages 484-509.

Under the term anti blocking agent there is understood, for example Silica, Talc, Zeolites, crosslinked polymethylmethacrylate or polymethylsilesquioxane. A detailed description is given in Plastics Additives Handbook, 5th Edition 2001, Hans Zweifel Ed., Hanser (Hanser Publisher Munich, Hanser Gardner Publications, Inc. Cincinnati ISBN 3-446-21654-5, pages 585-600.

Under the term anti-fogging additives there are understood polymer additives, which do not prevent the formation of condensation per se. However, while water vapour condenses anti-fogging additives cause the condensate to spread evenly over the film's surface and run off, instead of forming droplets, cf. Plastics Additives Handbook, 5th Edition 2001, Hans Zweifel Ed., Hanser (Hanser Publisher Munich, Hanser Gardner Publications, Inc. Cincinnati ISBN 3-446-21654-5, pages 609-626).

Representative anti-fogging additives are glycerol monooleate, polyglycerol esters, sorbitan esters, ethoxylated sorbitan esters, nonylphenol ethoxylate or ethoxylated alcohols.

Under the term antistatic additives there are understood polymer additives, which increase the conductivity of thermoplastic polymers. Typical examples are fatty acid esters, ethoxylated alkylamines, diethanolamides, ethoxylated alcohols, polyetherester amides and complex mixtures, such as for example those sold under the trade name Ciba Irgastat® P18 or P22. A comprehensive overview is given for example in Plastics Additives Handbook, 5th Edition 2001, Hans Zweifel Ed., Hanser (Hanser Publisher Munich, Hanser Gardner Publications, Inc. Cincinnati ISBN 3-446-21654-5, pages 627-645).

Under the term flame retardant additives there are understood compounds selected from halogenated, phosphorus, boron, silicon and antimony compounds, metal hydroxides, metal hydrates, metal oxides and mixtures thereof.

The halogenated flame retardants useful in compositions of the present invention may be selected from organic aromatic halogenated compounds such as halogenated benzenes, biphenyls, phenols, ethers or esters thereof, bisphenols, diphenyloxides, aromatic carboxylic acids or polyacids, anhydrides, amides or imides thereof; organic cycloaliphatic or polycycloaliphatic halogenated compounds; and organic aliphatic halogenated compounds such as halogenated paraffins, oligo- or polymers, alkylphosphates or alkylisocyanurates. These components are largely known in the art, see e.g. U.S. Pat. No. 4,579,906 (e.g. col. 3, lines 30-41), U.S. Pat. No. 5,393,812; see also Plastics Additives Handbook, Ed. by H. Zweifel, 5^{th} Ed., Hanser Publ., Munich 2001, pp. 681-698.

Under the term hydrophilic/hydrophobic surface modifiers there are understood ionic or non-ionic surfactants. The surfactants are typically phosphonates, organic boron compounds, fatty alcohols, ethoxylated alcohols, ethoxylated phenolethers, fluorocarbons, siloxanes ethoxylated siloxanes. Further examples are given in WO 02/42530. The compounds are largely items of commerce and available, for example, under the following trade names: lrgasurf HL 560®, Atmer 103®, Atmer 502®, Igepal CO-210®, Igepal CO-520®, Zonyl FSO 100®, Zonyl FSN 100®, Zonyl FISO, Tegopren 5847®, Tegopren 5878®, Tegopren 5843® and Tegopren 5873®.

Under the term IR-absorbers there are understood polymer additives, which absorb electromagnetic radiation in the IR range, preferably in the near IR range. Typical examples are based on phtalocyanines and naphthalocyanines dyes, metal complex dyes, polymethine dyes, diphenylmethane, triphenylmethane and related dyes, quinone dyes, azo dyes, miscellaneous chromophoric systems and radical dyes, as for example described in Chem. Rev. 1992, 92, 1197-1226. Further examples are disclosed in JP-A-2003327865, EP-A-1 306 404, EP-A-1 266 931 or Chemical Abstract 117;112529.

Suitable Nucleating agents are given below. Conventional nucleating agents are usually soluble in polymer melts, and are also referred to as clarifiers.

1) Aromatic sorbitol acetals, for example:

1,3:2,4-bis(benzylidene)sorbitol, commercially available as Irgaclear D®, Millad 3905® and Gel All D®;

1,3:2,4-bis(4-methylbenzylidene)sorbitol, commercially available as Irgaclear DM®, Millad 3940®, NC-6 (Mitsui®) and Gel All MD®;

1,3:2,4-bis(3,4-dimethylbenzylidene)sorbitol, commercially available as Millad 3988®;

1,3:2,4-bis(4-ethylbenzylidene)sorbitol, commercially available as NC-4 (Mitsui®).

Further examples of conventional nucleating agents are the less soluble or insoluble nucleating agents, commonly referred to as nucleators.

2) Nucleating agents based upon salts of phosphoric acid, for example:

2,2′-Methylen-bis-(4,6-di-tert-butylphenyl)phosphate, commercially available as Adeka Stab NA11® and Adeka Stab NA21®.

3) Nucleating agents based upon salts of carboxylic acid, for example:

sodium benzoate

Di-sodium salt of cis-endo-bicyclo(2.2.1)heptane 2,3-dicarboxylic acid (CAS no. 351870-33-2)=“Hyperform HPN-68® of Milliken;

also nucleating agents based upon salts of rosin/adiebetic acid, as for example:

Pinecrystal KM-1300®;

Pinecrystal KM-1600®.

4) Nucleating agents based upon carboxy aluminum-hydroxide, for example:

aluminum hydroxy-bis[4-(tert-butyl)benzoate], commercially available as Sandostab 4030®.

5) Other nucleating agents, for example, Zinc (II) monoglycerolate, commercially available as Prifer 3888® and Prifer 3881®.

Under the term scratch resistance additives there are understood polymer additives, which improve scratch resistance of surfaces. Typical examples are polysiloxanes, as, for example, disclosed in U.S. Pat. No. 6,080,489 or EP 1 211 277.

Generally preferred is a composition wherein the polymer additive is selected from the group consisting of light stabilizers, heat stabilizers, processing stabilizers, flame retardants, nucleating agents and antistatic agents.

Particularly preferred is a composition wherein the polymer additive is selected from the group consisting of light stabilizers, heat stabilizers and processing stabilizers.

A further aspect of the invention is a process for preparing the polymer additive containing SiO_{z} flakes, comprising

a) suspending the SiO_{z} flakes in water or in an organic solvent or mixtures thereof,

b) adding a dissolved or dispersed polymer additive to the SiO_{z} suspension, and

c) isolating the polymer additive containing SiO_{z} flakes, wherein 0.70≦z≦2.0.

As already mentioned above, incorporation of the polymer additive into the pores of the SiO_{z} flakes can be achieved by diffusion, precipitation, covalent bonding and/or ion exchange.

In order to support the incorporation, the liquid medium may be partially or completely evaporated.

Yet another aspect of the invention is a composition comprising

a) a thermoplastic, elastomeric or partially crosslinked polymer;

b) a porous SiO_{z} flake prepared by physical vapor deposition, wherein 0.70≦z≦2.0 which has incorporated at least partly in the pores

c) a polymer additive selected from the group consisting of light stabilizers, heat stabilizers, processing stabilizers, acid scavengers, anti-blocking agents, anti-fogging agents, antistatic agents, flame retardants, hydrophilic/hydrophobic surface modifiers, IR-reflectors, IR-absorbers, nucleating agents, scratch resistance additives and thermally conductive additives.

Examples for thermoplastic, elastomeric or partially crosslinked polymers are given below.

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:

a) radical polymerisation (normally under high pressure and at elevated temperature).

b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids, and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins, acrylic resin type, epoxy resin type, urethane resin type, powder type, chlorinated rubber type, or phenolic paint and melamine/formaldehyde resins.

23. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

24. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Preferably the polymer, component a) is a thermoplastic or thermosetting resin, such as polyethylene (for example LDPE, HDPE or MDPE), polypropylene, polyvinyl chloride (PVC), acrylonitrile-butadiene-styrene copolymer (ABS), nylons, polyesters, unsaturated polyesters (UP), polyvinylidene chloride, polyamides, styrene-acrylonitrile copolymers (SAN), polystyrene (PS), polymethyl methacrylate (PMMA), polyethylene terephthalate (PET), polyacetals, polyvinyl alcohol, polycarbonate, acrylic resins, fluoroplastics, polyurethane (PUR), thermoplastic polyurethane (TPU), phenolic resins, urea resins, melamine resins, unsaturated polyester resins, epoxy resins, urethane resins, rayon, urea formaldehyde resin (UF), cuprammonium rayon, acetates, triacetates, vinylidene, natural or synthetic rubbers, or a paint, such as a lyophilic paint, lacquer, varnish, and alkyl resin type, aminoalkyd resin type, vinyl resin type, acrylic resin type, epoxy resin type, urethane resin type, powder type, chlorinated rubber type, or phenolic paint.

Particularly preferred is a composition wherein the polymer, component a) is a thermoplastic polymer.

Special preference is given to a composition wherein the polymer, component a) is a polyolefin.

The SiO_{z} flakes of the invention and optional further components may be added to the polymer material individually or mixed with one another. If desired, the individual components can be mixed with one another before incorporation into the polymer for example by dry blending, compaction or in the melt.

The incorporation of the SiO_{z} flakes of the invention and optional further components into the polymer is carried out by known methods such as dry blending in the form of a powder, or wet mixing in the form of solutions, dispersions or suspensions for example in an inert solvent, water or oil. The SiO_{z} flakes of the invention and optional further additives may be incorporated, for example, before or after molding or also by applying the dissolved or dispersed SiO_{z} flakes to the polymer material, with or without subsequent evaporation of the solvent or the suspension/dispersion agent. They may be added directly into the processing apparatus (e.g. extruders, internal mixers, etc.), e.g. as a dry mixture or powder or as solution or dispersion or suspension or melt.

The incorporation can be carried out in any heatable container equipped with a stirrer, e.g. in a closed apparatus such as a kneader, mixer or stirred vessel. The incorporation is preferably carried out in an extruder or in a kneader. It is immaterial whether processing takes place in an inert atmosphere or in the presence of oxygen.

The addition of the SiO_{z} flakes to the polymer can be carried out in all customary mixing machines in which the polymer is melted and mixed with the additives. Suitable machines are known to those skilled in the art. They are predominantly mixers, kneaders and extruders.

The process is preferably carried out in an extruder by introducing the SiO_{z} flakes during processing.

Particularly preferred processing machines are single-screw extruders, contrarotating and corotating twin-screw extruders, planetary-gear extruders, ring extruders or cokneaders. It is also possible to use processing machines provided with at least one gas removal compartment to which a vacuum can be applied.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), very particularly preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components are added, these can be premixed or added individually.

The SiO_{z} flakes of the invention and optional further additives can also be sprayed onto the polymer material. They are able to dilute other additives (for example the conventional additives indicated above) or their melts so that they can be sprayed also together with these additives onto the material. Addition by spraying during the deactivation of the polymerization catalysts is particularly advantageous; in this case, the steam evolved may be used for deactivation of the catalyst. In the case of spherically polymerized polyolefins it may, for example, be advantageous to apply the SiO_{z} flakes of the invention, optionally together with other additives, by spraying.

The SiO_{z} flakes of the invention and optional further additives can also be added to the polymer in the form of a masterbatch (“concentrate”) which contains the components in a concentration of, for example, about 1% to about 40% and preferably 2% to about 20% by weight incorporated in a polymer. The polymer must not be necessarily of identical structure as the polymer where the additives are added finally. In such operations, the polymer can be used in the form of powder, granules, solutions, suspensions or in the form of latices.

Incorporation can take place prior to or during the shaping operation, or by applying the dissolved or dispersed SiO_{z} flakes to the polymer, with or without subsequent evaporation of the solvent. In the case of elastomers, these can also be stabilized as latices. A further possibility for incorporating the SiO_{z} flakes of the invention into polymers is to add them before, during or directly after the polymerization of the corresponding monomers or prior to crosslinking. In this context the SiO_{z} flakes of the invention can be added as it is or else in encapsulated form (for example in waxes, oils or polymers).

The materials containing the SiO_{z} flakes of the invention described herein can be used for the production of moldings, rotomolded articles, injection molded articles, blow molded articles, films, tapes, mono-filaments, fibers, nonwovens, profiles, adhesives or putties, surface coatings and the like.

Besides the afore mentioned effects, which result from the incorporated polymer additives, there are additional benefits resulting from the SiO_{z} flakes per se. Due to the porous shape of the SiO_{z} flakes, they can act as catalyst scavengers or oxygen scavengers. They reinforce the mechanical properties of the polymers and provide additional gas barrier properties. Further application areas can be in gasseparation membranes, hydrogenstorage for fuel-cells, fabrication as aerogele or support for cellbreeding.

The following examples, which have been carried out in analogy to example 1 of PCT/EP2004/000137 illustrate the invention.

### EXAMPLE 1

Two separate evaporators arranged in a vacuum chamber (<10⁻¹ Pa) are fed with SiO and NaCl powder, respectively. A rotating carrier to which an aluminium foil is attached mechanically is arranged above the evaporators. A NaCl layer (90 nm) is first sublimated onto the aluminium foil. Then the SiO evaporator is heated and the SiO begins to sublimate while salt is still sublimated. In this manner salt and SiO are sublimated simultaneously onto the NaCl layer. The simultaneous vaporization of salt and SiO is continued until a thickness of 300 nm is achieved. Sublimation is terminated, the aluminium foil of the carrier is removed and immersed into distilled water. The NaCl layer as well as the salt contained in the SiO matrix dissolves in water, whereby silicon oxide flakes are obtained. Porous SiO_{z} flakes can be obtained by heating the silicon oxide flakes in air at a temperature greater than 500° C. for several hours.

Results: porous SiO_{z} flakes with a BET=712 m²/g and pore sizes up to 30 nm.

### EXAMPLE 2

A solution of 0.1 g Tinuvin 328 (benzotriazole UVA of Ciba Specialty Chemicals) in 50 ml toluene is prepared and 2.0 g of porous SiO_{z} flakes of example 1 are added slowly with continuous stirring. The suspension is stirred for 7 days at room temperature, filtered, rinsed with de-ionized water and methanol. The residue is dried in vacuo at 35° C.

The resulting SiO_{z} flakes are incorporated into a polyethylene film, which is then subjected to accelerated weathering. The film exhibits improved weather resistance compared to a film containing no SiO_{z} flakes.

1. A composition comprising
a) a porous SiO_{z} flake prepared by physical vapor deposition, wherein 0.70≦z≦2.0 which has incorporated at least partly in the pores
b) a polymer additive selected from the group consisting of light stabilizers, heat stabilizers, metal deactivators, processing stabilizers, acid scavengers, anti-blocking agents, anti-fogging agents, antistatic agents, flame retardants, hydrophilic/hydrophobic surface modifiers, IR-reflectors, IR-absorbers, nucleating agents, scratch resistance additives and thermally conductive additives,
wherein the surface of the porous SiO_{z} flakes is greater than 500 m²/g.

2. A composition according to claim 1 wherein the flakes have a length of from 100 nm to 5 mm, a width of from 100 nm to 2 mm, and a thickness of from 20 nm to 1.5 μm, and a ratio of length to thickness of at least 2:1.

3. A composition according to claim 1 wherein the amount of the polymer additive in the SiO_{z} flakes is 0.001 to 20.0 percent by weight based on the weight of the SiO_{z} flakes.

4. A composition according to claim 1 wherein the polymer additive is selected from the group consisting of light stabilizers, heat stabilizers, processing stabilizers, flame retardants, nucleating agents and antistatic agents.

5. A composition according to claim 1 wherein the polymer additive is selected from the group consisting of light stabilizers, heat stabilizers and processing stabilizers.

6. A process for preparing the composition according to claim 1, comprising
a) suspending the SiO_{z} flakes in water or in an organic solvent or mixtures thereof,
b) adding a dissolved or dispersed polymer additive according to claim 1 to the SiO_{z} suspension, and
c) isolating the polymer additive containing SiO_{z} flakes, wherein 0.70≦z≦2.0.

7. A composition comprising
a) a thermoplastic, elastomeric or partially crosslinked polymer;
b) a porous SiO_{z} flake prepared by physical vapor deposition, wherein 0.70≦z≦2.0 which has incorporated at least partly in the pores
c) a polymer additive selected from the group consisting of light stabilizers, heat stabilizers, processing stabilizers, acid scavengers, anti-blocking agents, anti-fogging agents, antistatic agents, flame retardants, hydrophilic/hydrophobic surface modifiers, IR-reflectors, IR-absorbers, nucleating agents, scratch resistance additives and thermally conductive additives,
wherein the surface of the porous SiO_{z} flakes is greater than 500 m²/g.

8. A composition according to claim 7 wherein the polymer, component a), is a thermoplastic or thermosetting resin selected from polyethylene, polypropylene, polyvinyl chloride (PVC), acrylonitrile-butadiene-styrene copolymer (ABS), nylons, polyesters, unsaturated polyesters (UP), polyvinylidene chloride, polyamides, styrene-acrylonitrile copolymers (SAN), polystyrene (PS), polymethyl methacrylate (PMMA), polyethylene terephthalate (PET), polyacetals, polyvinyl alcohol, polycarbonate, acrylic resins, fluoroplastics, polyurethane (PUR), thermoplastic polyurethane (TPU), phenolic resins, urea resins, melamine resins, unsaturated polyester resins, epoxy resins, urethane resins, rayon, urea formaldehyde resin (UF), cuprammonium rayon, acetates, triacetates, vinylidene and natural or synthetic rubbers,
or is a paint selected from lyophilic paint, lacquer, varnish, alkyl resin paint, aminoalkyd resin paint, vinyl resin paint, acrylic resin paint, epoxy resin paint, urethane resin paint, powder paint, chlorinated rubber paint and phenolic paint.

9. A composition according to claim 7 wherein the polymer, component a), is a thermoplastic polymer.

10. A composition according to claim 7 wherein the polymer, component a), is a polyolefin.
